(19) United States
(12) Patent Application Publication
(10) Pub. No.: US 2026/0170387 A1
(43) Pub. Date: Jun. 18, 2026

(54) Quantum Error Correction using Tesseract Subsystem Code

(71) Applicant: Microsoft Technology Licensing, LLC, Redmond, WA (US)

(72) Inventor: Benjamin Walter REICHARDT, Santa Barbara, CA (US)

(73) Assignee: Microsoft Technology Licensing, LLC, Redmond, WA (US)

(21) Appl. No.: 18/983,094

(22) Filed: Dec. 16, 2024

Related U.S. Application Data
(60) Provisional application No. 63/688,222, filed on Aug. 28, 2024.

(51) Int. Cl. G06N 10/70; G06N 10/40

(52) U.S. Cl. CPC G06N 10/70; G06N 10/40

(57) ABSTRACT

A quantum computing device is provided. The quantum computing device is configured to perform quantum error correction using a tesseract subsystem code in which two encoded logical qubits of a [symbol] 16, 6, 4 [symbol] tesseract code are used as gauge qubits.

### CROSS REFERENCE TO RELATED APPLICATIONS

This application claims priority to U.S. Provisional Patent Application Ser. No. 63/688,222, filed Aug. 28, 2024, the entirety of which is hereby incorporated herein by reference for all purposes.

### BACKGROUND

Even the best qubits are insufficiently reliable to run large quantum algorithms. By encoding qubits into error-correcting codes, dramatic reductions in effective error rates should be possible. Fault tolerance allows software to handle hardware flaws—with a cost in overhead.

### SUMMARY

According to one aspect of the present disclosure, a quantum computing device is provided. The quantum computing device is configured to perform quantum error correction using a tesseract subsystem code in which two encoded logical qubits of a [symbol] 16, 6, 4 [symbol] tesseract code are used as gauge qubits.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a quantum computing device, according to one example.

FIG. 2 schematically shows a [symbol] 16,6,4 [symbol] color code on a tesseract, according to the example of FIG. 1.

FIG. 3A shows an example code presentation of the tesseract subsystem code, according to the example of FIG. 1.

FIG. 3B shows an example quantum error correction according to the code presentation of FIG. 3A.

FIGS. 4A-4D show example circuits that measure weight-four operators, according to the example of FIG. 1.

FIG. 5A shows generators of a [symbol] 15,7,3 [symbol] Hamming code obtained by removing a qubit from the [symbol] 16,6,4 [symbol] tesseract code, according to the example of FIG. 2.

FIG. 5B shows two [symbol] 8,3,2 [symbol] color codes on the cube that are obtained by applying CNOT gates between two halves of the [symbol] 16,6,4 [symbol] tesseract code, according to the example of FIG. 2.

FIG. 5C shows an encoding circuit for a [symbol] 4,2,2 [symbol] color code along with four stacked copies of the encoding circuit, according to the example of FIG. 2.

FIG. 6 shows examples of quantum error correction using the tesseract subsystem code, according to the example of FIG. 3A.

FIG. 7 shows a complete example of three rounds of X and Z error correction, according to the example of FIG. 6.

FIG. 8A shows a fault-tolerant postselected circuit that prepares encoded |++0000> [symbol] , according to the example of FIG. 1.

FIG. 8B shows a postselected circuit, two copies of which may be used to fault-tolerantly prepare the encoded |+0+0+0 [symbol] , according to the example of FIG. 1.

FIG. 9 shows examples of additional logical measurements that may be performed within the tesseract subsystem code, according to the example of FIG. 3A.

FIG. 10 shows the generators of the group of permutation automorphisms for the tesseract subsystem code, according to the example of FIG. 3A.

FIG. 11A shows an unencoded state preparation circuit used in a path-4 state preparation experiment, according to the example of FIG. 1.

FIGS. 11B-11D show supports of operator measurements performed in the path-4 state preparation experiment, according to the example of FIG. 11A.

FIG. 12A shows a circuit used to prepare an 8-qubit graph state in a cube-8 state preparation experiment, according to the example of FIG. 1.

FIG. 12B shows an encoded cube-8 circuit 154 used in the cube-8 state preparation experiment, according to the example of FIG. 12A.

FIG. 13A shows a circuit that prepares the 12-qubit cat state, according to the example of FIG. 1.

FIG. 13B shows supports of operator measurements performed in a 12-qubit cat state experiment, according to the example of FIG. 13A.

FIG. 14A shows a circuit used as an unencoded physical baseline in a repeated error correction experiment, according to the example of FIG. 1.

FIG. 14B shows two instances of the circuit of FIG. 14A repeated in parallel.

FIG. 14C shows two instances of the circuit of FIG. 14A repeated in parallel with a compiler barrier inserted before the final measurements.

FIG. 15A shows a plot of logical error probability over 10 rounds of repeated error correction, according to the example of FIGS. 14A-14C.

FIG. 15B shows a plot of acceptance probability over 10 rounds of repeated error correction, according to the example of FIGS. 14A-14C.

FIG. 15C shows a plot of logical error probability over 50 rounds of repeated error correction, according to the example of FIGS. 14A-14C.

FIG. 15D shows a plot of acceptance probability over 50 rounds of repeated error correction, according to the example of FIGS. 14A-14C.

FIG. 16A shows a flowchart of a method for use with a quantum computing device to perform quantum error correction, according to the example of FIG. 1.

FIGS. 16B-16C show additional steps of the method of FIG. 16A that may be performed in some examples.

FIG. 17 shows a schematic view of an example computing environment, according to the example of FIG. 1.

### DETAILED DESCRIPTION

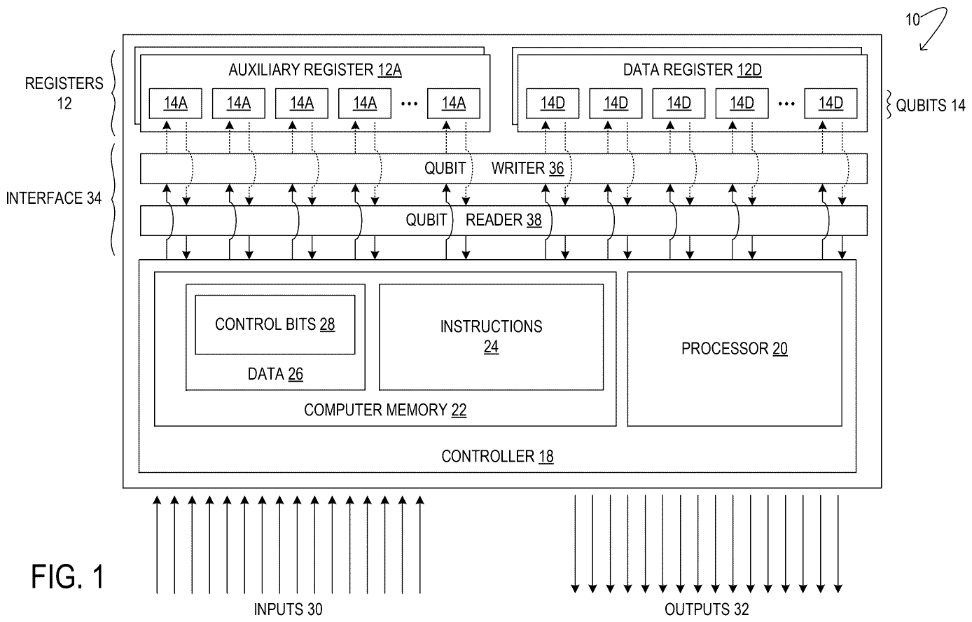

FIG. 1 shows aspects of an example quantum computing device 10 configured to execute quantum-logic operations. Whereas conventional computer memory holds digital data in an array of bits and enacts bit-wise logic operations, a quantum computer holds data in an array of qubits and operates quantum-mechanically on the qubits in order to implement the desired logic. Accordingly, quantum computing device 10 of FIG. 1 includes a set of qubit registers 12—e.g., data register 12D and auxiliary (or ‘ancillary’) register 12A. Each qubit register includes a series of qubits 14, with the data register 12D including a plurality of data qubits 14D and the auxiliary register 12A including a plurality of auxiliary qubits 14A. The number of qubits in a qubit register is not particularly limited but may be determined based on the complexity of the quantum logic to be enacted by the quantum computing device 10.

Qubits 14 of qubit register 12 may take various forms, depending on the desired architecture of quantum computing device 10. Each qubit may comprise: a superconducting Josephson junction, a trapped ion, a trapped atom coupled to a high-finesse cavity, an atom or molecule confined within a fullerene, an ion or neutral dopant atom confined within a host lattice, a quantum dot exhibiting discrete spatial- or spin-electronic states, electron holes in semiconductor junctions entrained via an electrostatic trap, a coupled quantum-wire pair, an atomic nucleus addressable by magnetic resonance, a free electron in helium, a molecular magnet, or a metal-like carbon nanosphere, as non-limiting examples. A qubit may be implemented in the plural processing states corresponding to different modes of light propagation through linear optical elements (e.g., mirrors, beam splitters and phase shifters), as well as in states accumulated within a Bose-Einstein condensate. More generally, each qubit 14 may comprise any particle or system of particles that can exist in two or more discrete quantum states that can be measured and manipulated experimentally.

Quantum computing device 10 includes a controller 18. The controller may include at least one processor 20 and associated computer memory 22. Processor 20 may be coupled operatively to peripheral componentry, such as network componentry, to enable the quantum computing device 10 to be operated remotely. Processor 20 may take the form of a central processing unit (CPU), a graphics processing unit (GPU), or the like. As such, controller 18 may comprise classical electronic componentry. The terms ‘classical’ and ‘non-quantum’ are applied herein to any component that can be modeled accurately without considering the quantum state of any individual particle therein. Classical electronic components include integrated, microlithographed transistors, resistors, and capacitors, for example. Computer memory 22 may be configured to hold program instructions 24 that cause processor 20 to execute any function or process of controller 18. The computer memory may also be configured to hold additional data 26. In some examples, data 26 may include a register of classical control bits 28 that influence the operation of the quantum computing device 10 during run time—e.g., to provide classical control input to one or more quantum-gate operations. In examples in which qubit register 12 is a low-temperature or cryogenic device, controller 18 may include control componentry operable at low or cryogenic temperatures—e.g., a field-programmable gate array (FPGA) operated at 77K. In such examples, the low-temperature control componentry may be coupled operatively to interface componentry operable at normal temperatures.

Controller 18 of quantum computing device 10 is configured to receive a plurality of inputs 30 and to provide a plurality of outputs 32. The inputs and outputs may each comprise digital and/or analog lines. At least some of the inputs and outputs may be data lines through which data is provided to and/or extracted from quantum computing device 10. Other inputs may comprise control lines via which the operation of the quantum computing device 10 may be adjusted or otherwise controlled.

Controller 18 is operatively coupled to qubit registers 12 via quantum interface 34. The quantum interface is configured to exchange data (solid lines) bidirectionally with the controller. The quantum interface is further configured to exchange signal associated with the data (dashed lines) bidirectionally with the qubit registers. Depending on the physical implementation of qubits 14, such signal may include electrical, magnetic, and/or optical signal. Via signal conveyed through the quantum interface, the controller may interrogate and otherwise influence the quantum state held in any, some, or all of the qubit registers, as defined by the collective quantum state of the qubits therein. To that end, the quantum interface includes qubit writer 36 and qubit reader 38. The qubit writer is configured to output a signal to one or more qubits of a qubit register based on write-data received from the controller. The qubit reader is configured to sense a signal from one or more qubits of a qubit register and to output read-data to the controller based on the signal. The read-data received from the qubit reader may, in some examples, be an estimate of an observable to the measurement of the quantum state held in a qubit register. Taken together, controller 18 and interface 34 may be referred to as a ‘control system’.

In some examples, suitably configured signal from qubit writer 36 may interact physically with one or more qubits 14 of a qubit register 12, to trigger measurement of the quantum state held in the one or more qubits. Qubit reader 38 may then sense a resulting signal released by the one or more qubits pursuant to the measurement, and may furnish read-data corresponding to the resulting signal to controller 18. Stated another way, the qubit reader may be configured to output, based on the signal received, an estimate of one or more observables reflecting the quantum state of one or more qubits of a qubit register, and to furnish the estimate to controller 18. In one non-limiting example, the qubit writer may provide, based on data from the controller, an appropriate voltage pulse or pulse train to an electrode of one or more qubits, to initiate a measurement. In short order, the qubit reader may sense photon emission from the one or more qubits and may assert a corresponding digital voltage level on a quantum-interface line into the controller. Generally speaking, any measurement of a quantum-mechanical state is defined by the operator O corresponding to the observable to be measured; the result R of the measurement is guaranteed to be one of the allowed eigenvalues of O. In quantum computing device 10, R is statistically related to the qubit-register state prior to the measurement, but is not uniquely determined by the qubit-register state.

Pursuant to appropriate input from controller 18, quantum interface 34 may be configured to implement one or more quantum-logic gates to operate on the quantum state held in a qubit register 12. The term ‘state vector’ refers herein to the quantum state held in the series of qubits 14D of data register 12D of quantum computing device 10. Whereas the function of each type of logic gate of a classical computer system is described according to a corresponding truth table, the function of each type of quantum gate is described by a corresponding operator matrix. The operator matrix operates on (i.e., multiplies) the complex vector representing a qubit register state and effects a specified rotation of that vector in Hilbert space.

A suitably configured signal from qubit writer 36 of quantum interface 34 may interact physically with one or more qubits 14 of a qubit register 12 so as to assert any desired quantum-gate operation. As noted above, the desired quantum-gate operations include specifically defined rotations of a complex vector representing a qubit register state. In some examples, in order to effect a desired rotation O, the qubit writer may apply a predetermined signal level Sᵢ for a predetermined duration Tᵢ. In some examples, plural signal levels may be applied for plural sequenced or otherwise associated durations to assert a quantum-gate operation on one or more qubits of a qubit register. In general, each signal level Sᵢ and each duration Tᵢ is a control parameter adjustable by appropriate programming of controller 18.

The terms ‘quantum circuit’ and ‘quantum algorithm’ are used herein to describe a predetermined sequence of elementary quantum-gate and/or measurement operations executable by quantum computing device 10. A quantum circuit may be used to transform the quantum state of a qubit register 12 to effect a classical or non-elementary quantum-gate operation or to apply a density operator, for example.

Each qubit 14 of any qubit register 12 may be interrogated via quantum interface 34 so as to reveal with confidence the standard basis vector |0 [symbol] or |1 [symbol] that characterizes the quantum state of that qubit. In some implementations, however, measurement of the quantum state of a physical qubit may be subject to error. Accordingly, any qubit 14 may be implemented as a logical qubit, which includes a grouping of physical qubits measured according to an error-correcting quantum algorithm or circuit that reveals the quantum state of the logical qubit with above-threshold confidence.

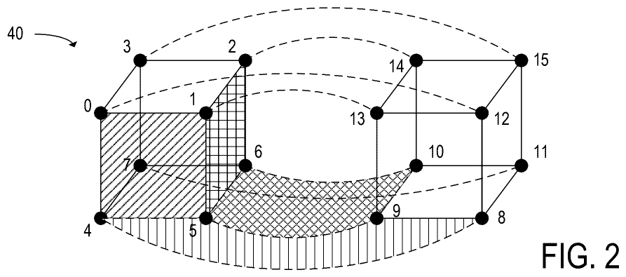

The present disclosure introduces a new fault-tolerance scheme that is well-suited to state-of-the-art quantum computers. This fault-tolerance scheme may, for example, be implemented at the quantum computing device 10 of FIG. 1. The scheme comprises a 16-qubit “tesseract” code 40, depicted in FIG. 2, and methods for error correction and encoded computation. It is qubit efficient, with just a four-to-one overhead in qubit count, but also offers expeditious error correction (single shot, with only two extra qubits) and enough protection to reduce error rates substantially. The tesseract code 40 is distance four, so three physical faults have to occur to cause a logical error. FIG. 2 shows the [symbol] 16,6,4 [symbol] color code on the 4D hypercube, or tesseract. Each of the 16 vertices is a qubit. Cubes are X and Z stabilizers, and squares are logical operators, e.g., 0145.

The tesseract code 40 has been studied before. However, the systems and methods provided herein deliberately sacrifice two of the original six encoded qubits. Accordingly, the quantum computing device 10 is configured to perform quantum error correction using a tesseract subsystem code in which two encoded logical qubits of the [symbol] 16, 6, 4 [symbol] tesseract code 40 are used as gauge qubits. Protecting four of the encoded qubits instead of six dramatically simplifies fault-tolerant error correction and computation. In particular, it lets error correction work by measuring operators supported on only four qubits, instead of eight, which increases efficiency and gives the error correction the single-shot property.

Experiments were conducted to test the fault-tolerance scheme on Quantinuum's H1-1 (20 qubit) and H2-1 (56 qubit) quantum computers, obtaining and computing with up to 12 logical qubits in three code blocks. Table I summarizes the experiments. Path-4 demonstrates an encoded CNOT gate within a code block; targeted operations allow more flexible computation than if we were limited to transversal gates in which every encoded qubit gets the same operation. Cube-8 uses three rounds of transversal CNOT gates between blocks, with two rounds of error correction; this demonstrates a deeper circuit on more encoded qubits. Cat-12 prepares a high-fidelity state on 12 logical qubits. Finally, the experiments show five rounds of error correction on four and eight encoded qubits, paving the way for deeper logical circuits on more encoded qubits. All of these encoded operations work with significantly lower error rates than the unencoded baseline versions.

Table I: Computing fault tolerantly on encoded data gives dramatic error rate improvements over baseline, unencoded circuits. Path-4 is run on H1-1, the others on H2-1. The first three experiments prepare graph states, on four, eight, or 12 qubits. For these experiments, each reported error rate is averaged over X and Z measurement settings. Full data is given in Table III.

| | | Baseline error | Encoded error | |
|---|---|---|---|---|
| Experiment | Qubits | rate | rate | Gain |
| Path-4 | 4 | 1.5(2)% | ${0.1}_{- 0.06}^{+ 0.11} \%$ | 15× |
| Cube-8 | 8 | 2.3(3)% | ${0.2}_{- 0.1}^{+ 0.2} \%$ | 11.5× |
| Cat-12 | 12 | 2.4(3)% | ${0.09}_{- 0.07}^{+ 0.18} \%$ | 26.7× |
| Error correction ×5 | 4 | 2.7(4)% | ${0.11}_{- 0.09}^{+ 0.21} \%$ | 24.5× |
| | 8 | 5.6(6)% | ${0.5}_{- 0.4}^{+ 0.8} \%$ | 11.2× |

Note that with a distance-four code, two faults may bring the system to an uncorrectable state. When an uncorrectable state is detected, the fault-tolerance procedure rejects the trial. This “postselection” increases the time overhead to collect a given amount of encoded data. The acceptance rates in the experiments are at least 50%, so this overhead is not critical. The acceptance rate is far higher than with a distance-two code for which a single fault can cause rejection. Still, the overhead tends to increase for longer experiments on more code blocks.

Compared to codes that have been implemented previously, the tesseract subsystem code has a higher rate (ratio of encoded to physical qubits) and higher distance. These parameters come with tradeoffs. A higher rate usually means a code requiring more physical qubits, higher connectivity between those qubits, and harder logical computation. A higher distance often forces a lower rate, and sometimes more complicated fault-tolerance schemes, meaning physical error rates have to be lower before the code is useful. For current ion trap devices, with 20+ well-connected qubits, the tesseract code is in a sweet spot.

The latest generations of quantum hardware are enabling impressive demonstrations of fault-tolerant quantum error correction and computation, validating fault tolerance theory's applicability to real devices. Distance-two codes have been implemented with two, three, four, eight, and 48 logical qubits, divided across 16 [symbol] 8,3,2 [symbol] code blocks. Distance-two codes are challenging to scale because they cannot correct errors, only detect them, and this leads to high rejection rates.

For repeated error correction, Ryan-Anderson et al. have experimented with up to six rounds of error correction, but on only one encoded qubit, in the [symbol] 7,1,3 [symbol] color code, and after five rounds the logical error rate was over 10%. Postler et al. implemented repeated error correction on the same code, and after one round the error rate was already about 35%. Silva et al. have shown three rounds of error correction with a [symbol] 12,2,4 [symbol] code, with a logical error rate of only 0.8 (3) %, beating a physical baseline. The experiments discussed herein run more rounds of error correction, on more encoded qubits, with lower logical error rates and less postselection.

As for state preparation and computation with error-correcting codes, Mayer et al. perform a computation on three encoded qubits, using the [symbol] 7,1,3 [symbol] code, notably including non-Clifford gates (though not implemented fault-tolerantly), but not using rounds of quantum error correction. Hong et al. prepare a four-qubit cat state encoded in a [symbol] 25,4,3 [symbol] code on H2-1, with a

$${0.3}_{- 0.1}^{+ 0.2} \%$$

error rate. Bluvstein et al. prepare a four-qubit cat state encoded in the [symbol] 7,1,3 [symbol] code, with a fidelity of only 72 (2) % using error correction, ranging to

$${99.85}_{- 1.}^{+ 0.1} \%$$

using run error detection.

Table II summarizes the results of experiments preparing encoded cat states.

| Reference | Logical qubits | Fidelity |
|---|---|---|
| Hong et al. | 4 in [symbol] 25, 4, 3 [symbol] code | ${99.5}_{- 0.4}^{+ 0.2} \% to {99.7}_{- 0.3}^{+ 0.2} \%$ |
| Bluvstein et al. | 4 in [symbol] 7, 1, 3 [symbol] code | 72(2)% error correction |
| | | ${99.85}_{- 1.}^{+ 0.1} \% error$ |
| | | detection |
| Here | 12 in [symbol] 16, 4, 4 [symbol] code | ${99.8}_{- 0.4}^{+ 0.1} \%$ |

Work prior to the Cube-8 experiment has not used multiple rounds of error correction as part of a state-preparation procedure. The present disclosure is notable in showing multiple rounds of error correction on multiple code blocks, with more encoded qubits and a variety of logical operations-all at error rates an order of magnitude lower than the unencoded versions.

The [symbol] 16,6,4 [symbol] tesseract code 40 is a self-dual color code on the 4D hypercube, encoding into 16 physical qubits six logical qubits protected to distance four (see FIG. 2). This code was introduced by Delfosse et al. and simulated extensively, with a fault-tolerance scheme requiring weight-eight measurements, in Prabhu et al. The scheme presented in the present disclosure sacrifices two encoded qubits, not using them to store data (except sometimes temporarily). The sacrificed qubits are used as gauge qubits, even though they have the same distance as the data qubits. The resulting [symbol] 16,4,4 [symbol] is referred to as the tesseract subsystem code.

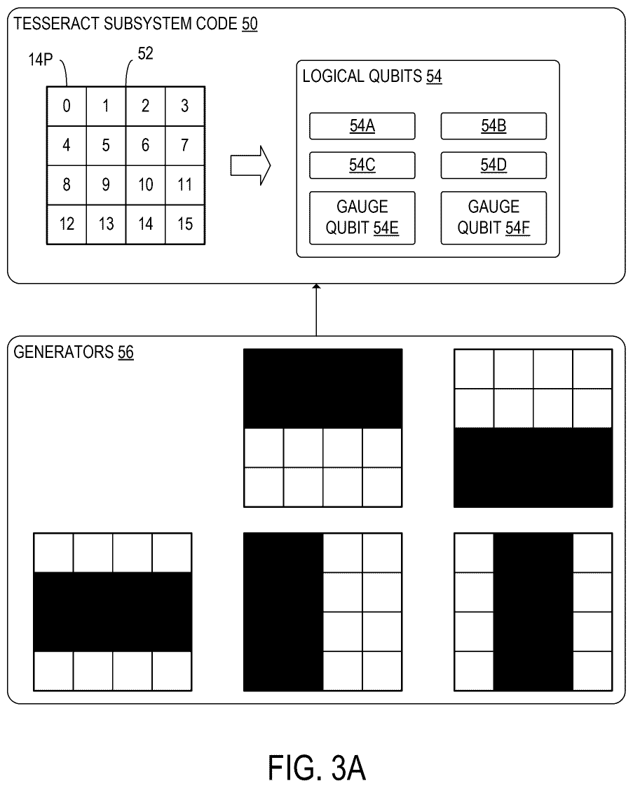

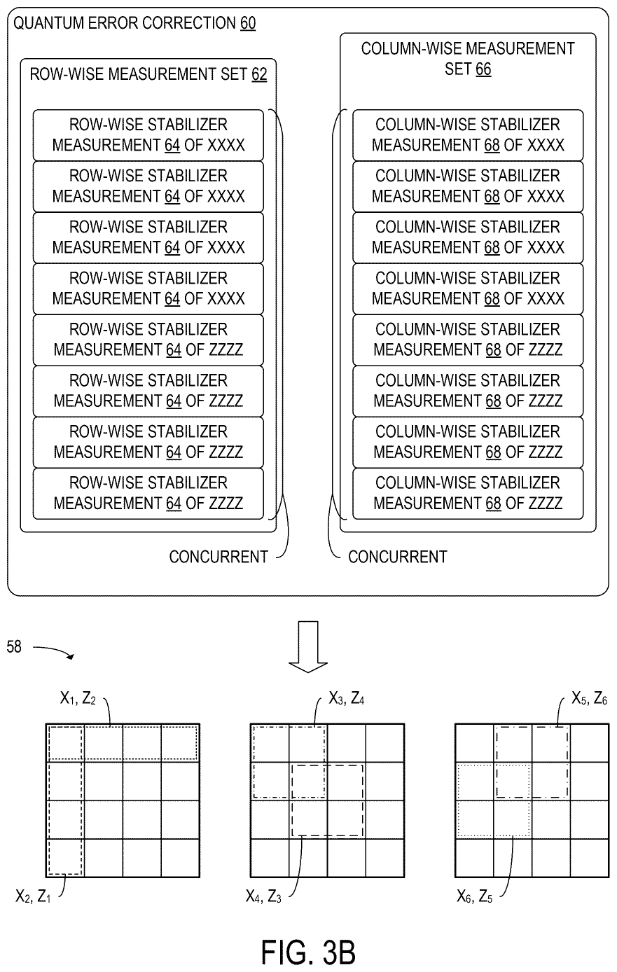

The advantages of sacrificing two encoded qubits are discussed below. FIG. 3A shows an example code presentation of the tesseract subsystem code 50. In addition, FIG. 3B shows an example quantum error correction 60 according to the code presentation of FIG. 3A. As shown in FIG. 3A, it is convenient to arrange the tesseract subsystem code's 16 physical qubits 14P in a 4×4 grid 52. The 16 physical qubits 14P of the tesseract subsystem code 50 are used to form six logical qubits 54, including data qubits 54A, 54B, 54C, and 54D and gauge qubits 54E and 54F. The X and Z stabilizers are supported on pairs of rows and pairs of columns; a set of generators 56 is shown in black. FIG. 3B highlights 58 the supports of the logical operators in the basis used in this example. For example, logical Z₂ is Z₀Z₁Z₂Z₃. The weight-four logical operators are not self-dual but instead come in three pairs of two.

In the code presentation depicted in FIGS. 3A-3B, X^{⊗4} along any row of the grid is a representative of encoded X₁. The product of any two X^{⊗4} rows is a stabilizer. Similarly, X^{⊗4} along any column is a representative of encoded X₂. The product of any two columns gives a stabilizer. Thus, measuring the first two logical qubits, using weight-four measurements, is enough to determine the syndromes for all X stabilizers, enabling Z error correction. Weight-four measurements are much easier to make fault-tolerantly to distance four than weight-eight measurements. Moreover, it is fault-tolerant to measure the four rows in parallel followed by the columns in parallel; error correction is “single-shot.”

As depicted in FIG. 3B, the quantum computing device 10 is configured to perform the quantum error correction 60 at least in part by performing, on a plurality of physical qubits 14P, one or more row-wise measurement sets 62 of row-wise stabilizer measurements 64 and performing one or more column-wise measurement sets 66 of column-wise stabilizer measurements 68. The row-wise stabilizer measurements 64 and column-wise stabilizer measurements 68 may each be X_{⊗4} measurements or Z^{⊗4} measurements. The row-wise stabilizer measurements 64 and the column-wise stabilizer measurements 68 are each single-shot weight-four measurements, as discussed above.

The one or more row-wise measurement sets 62 and the one or more column-wise measurement sets 66 may each include a plurality of measurements of a first stabilizer operator that are performed concurrently with a plurality of measurements of a second stabilizer operator. When measuring X^{⊗4} across a row (logical X₁), the tesseract subsystem code allows for concurrent measurement of Z^{⊗4} across the same row (logical Z₂). In addition, as shown in the example of FIG. 3B, the quantum computing device 10 may be configured to measure logical X₂ concurrently with logical Z₁; logical X₃ concurrently with logical Z₄; X^{⊗4} concurrently with logical Z₃; logical X₅ concurrently with logical Z₆; or logical X₆ concurrently with logical Z₅. The concurrent X₃ and Z₄ measurements, the concurrent X^{⊗4} and Z₃ measurements, the concurrent X₅ and Z₆ measurements, and the concurrent X₆ and Z₅ measurements shown in FIG. 3B are performed on squares of four physical qubits 14P each, rather than on rows or columns of the grid 52.

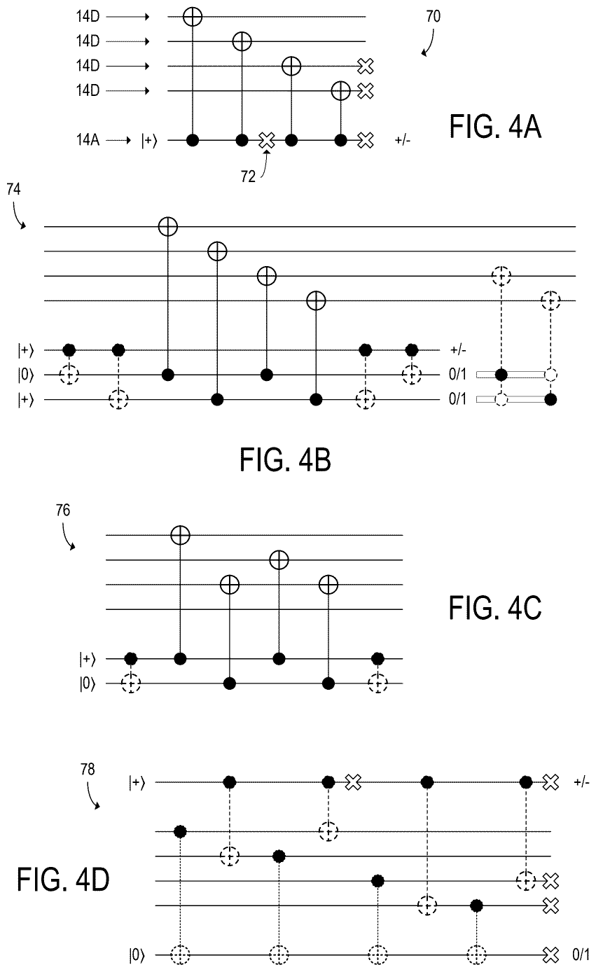

FIGS. 4A-4D show circuits to measure weight-four operators. The circuit 70 of FIG. 4A measures X^{⊗4}, but it is not fault tolerant, as a single X fault 72 on the ancilla qubit 14A can propagate to a weight-two error on the data qubits 14D. The circuit 74 shown in FIG. 4B, using one syndrome and two flag qubits, is fully fault tolerant. The corrections can be tracked classically, as part of the “Pauli frame.” The circuit 76 of FIG. 3C has a single flag qubit, which is enough to detect a possible correlated error, but not to correct it. A subsequent measurement that takes the flag into account can be used to correct the answer.

The circuit 78 of FIG. 4D allows X^{⊗4} and Z^{⊗4} to be measured concurrently. As shown in FIG. 4D, X^{⊗4} and Z can be efficiently and fault-tolerantly measured in parallel, with one measurement outcome flagging the other for possible correlated errors. Each pair of weight-four measurements is performed with eight CNOT gates, with two ancilla qubits. The same two ancilla qubits are reused for all measurements on a code block, so that one code block uses 18 physical qubits 14P in hardware. The circuit 78 of FIG. 4D allows for concurrent correction of X and Z errors, thereby providing a major efficiency advantage over existing sequential procedures.

In some applications, it is desirable to obtain uniformly random measurement results. However, repeating X^{⊗4} and Z^{⊗4} four times on disjoint qubit sets can have ambiguous results. For example, if one of the Z^{⊗4} measurements disagrees with the other three, that disagreement can mean that either a weight-one X error has been detected, or that a weight-two correlated X error has spread to the data.

The two gauge qubits 54E and 54F give the tesseract subsystem code 50 workspace for implementing targeted operations, such as H, CNOT or CZ, on any one or two encoded qubits within the same or different code blocks. These operations can be implemented by teleporting through the gauge qubits.

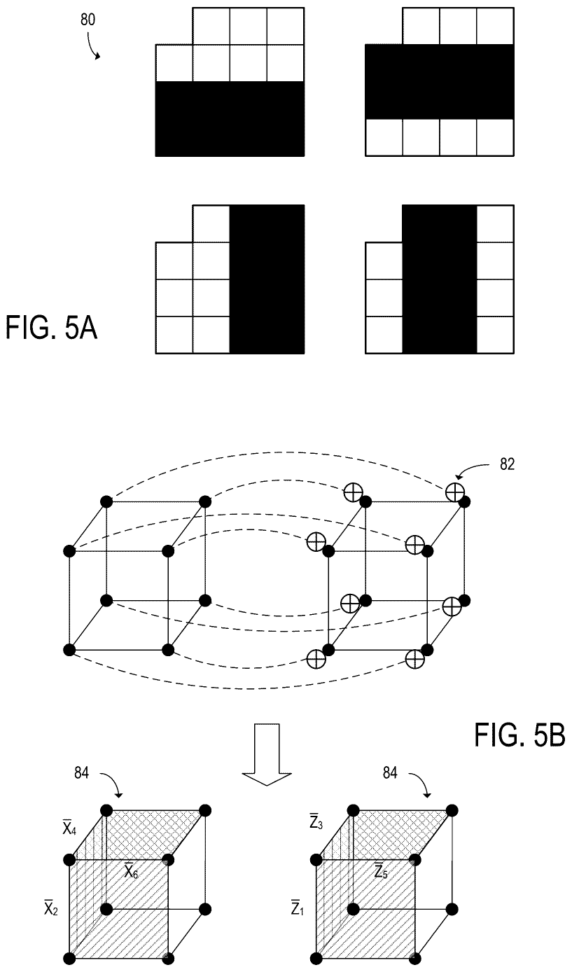

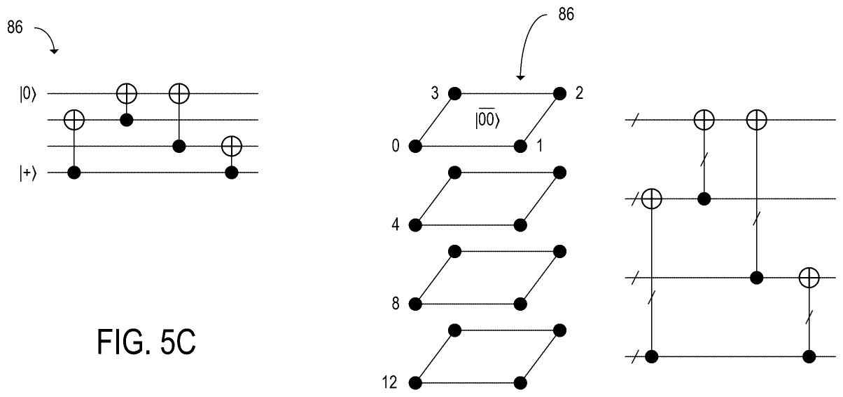

The tesseract code 40 is closely connected to other codes. It can be obtained by applying transversal CNOTs between the [symbol] 8,3,2 [symbol] color code on the 3D cube and its dual, or from four copies of the [symbol] 4,2,2 [symbol] color code on the square. FIGS. 5A-5C shows the relationship of the tesseract code to other codes. As shown in FIG. 5A, removing a qubit from the [symbol] 16,6,4 [symbol] code leaves the well-known [symbol] 15,7,3 [symbol] Hamming code. FIG. 5A depicts the generators 80 of the [symbol] 15,7,3 [symbol] Hamming code. As shown in FIG. 5B, applying CNOT gates 82 between two halves of the 16-qubit code 40 disentangles it into two [symbol] 8,3,2 [symbol] color codes 84 on the cube; the left color code has X distance 2 and Z distance 4, and the right color code vice versa. FIG. 5C shows an encoding circuit 86 for the [symbol] 4,2,2 [symbol] color code. Stacking four copies 88 of this color code, with the first in encoded |00 [symbol] (a cat state) and the last in encoded |++ [symbol] , and applying the same encoding circuit 86 transversally yields the [symbol] 16,4,4 [symbol] code with fixed gauge qubits.

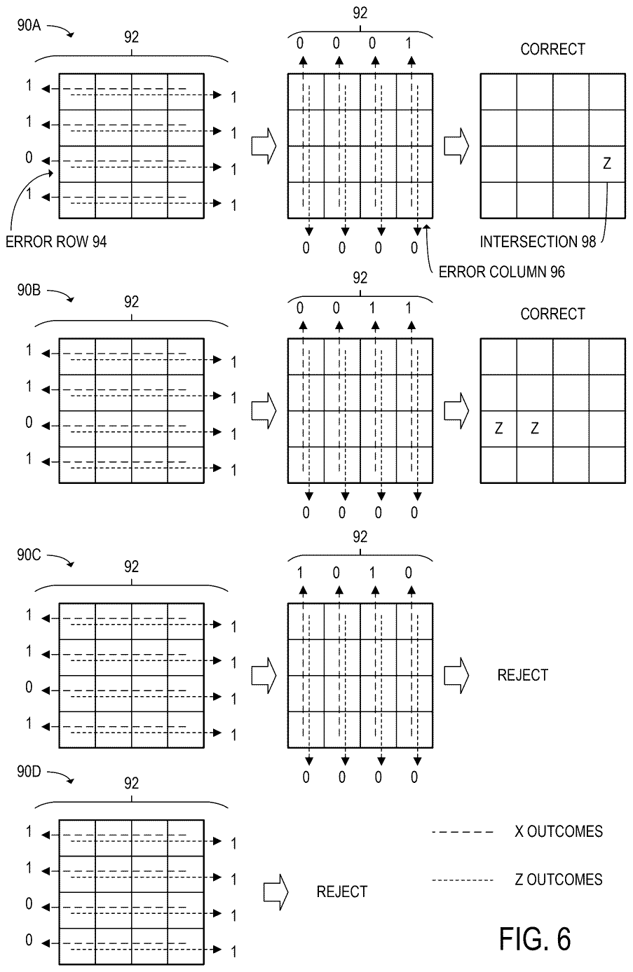

An efficient fault-tolerant error correction procedure is the foundation for any fault-tolerant quantum computation scheme. Example measurement sequences 90A, 90B, 90C, and 90D that each include one or more measurement rounds 92 are schematically depicted in FIG. 6. In the example of FIG. 6, one round of error correction includes measuring X^{⊗4} and Z^{⊗4} across four rows, then down four columns. In other examples, the quantum computing device 10 may instead be configured to measure X^{⊗4} and Z^{⊗4} along columns and then along rows. Accordingly, when performing the quantum error correction 60, the quantum computing device 10 is configured to alternate between the row-wise measurement sets 62 and the column-wise measurement sets 66 in successive measurement rounds 92. The measurement sequences 90A and 90B are examples in which the quantum computing device 10 alternates between row-wise stabilizer measurements 64 and column-wise stabilizer measurements 68.

The X^{⊗4} measurement outcomes across the rows may be random but are expected to be correlated. In the absence of noise, the X^{⊗4} measurements result in either (0, 0, 0, 0) or (1, 1, 1, 1). If one outcome disagrees with the other three, it indicates a Z error in that row. For example, (0, 1, 0, 0) and (1, 0, 1, 1) both indicate a Z error in the second row. The column X^{⊗4} measurements similarly identify the column of the Z error, thereby allowing the Z error to be corrected. Accordingly, performing the quantum error correction 60 further includes identifying, as a physical qubit 14P in the grid 52 at which an error has occurred, the physical qubit 14P located at an intersection 98 between an error row 94 and an error column 96. The error row 94 has a different measurement outcome from each other row included in the grid 52, and the error column 96 has a different measurement outcome from each other column included in the grid 52.

If one row X measurement disagrees with the others, and one column X measurement disagrees with the others, then a Z correction is applied to the row-column intersection 98. A disagreeing row X measurement also flags that row for a possible correlated ZZII or IIZZ error. However, if there are two 0 and two 1 row measurements (with no column flagged in the previous column measurements), the trial is rejected, as in the example measurement sequence 90D. In the example measurement sequence 90D, the quantum computing device 10 determines that the grid 52 has two error rows 94 that have different measurement outcomes from another two rows. In response to determining that the grid 52 has two error rows 94, the quantum computing device 10 is further configured to discard a quantum computation trial in which the quantum error correction is included. Thus, the trial is rejected if two rows disagree with the others, e.g., (0, 0, 1, 1) or (0, 1, 0, 1), indicating an uncorrectable error. In examples in which a column-wise measurement set 66 is performed prior to a row-wise measurement set 62, the trial may be rejected in response to determining that the grid 52 has two error columns 96 that have different measurement outcomes from another two columns.

In some examples, single faults can cause weight-two errors. In the circuit 78 of FIG. 4D, a single Z fault when measuring a column can cause a weight-two Z error in that column of qubits. Rejecting these first-order events would lead to an overly high rejection rate. In addition, if a single fault can cause weight-two errors, the logical error rate is second order. For a distance-four code, the logical error rate is expected to be third order.

Fortunately, when a single Z fault causes a weight-two Z error in a column, the Z fault is flagged by the X^{⊗4} column measurement. Thus, when measuring X^{⊗4} along the rows, the quantum error correction 60 proceeds differently when a column has been flagged for Z errors. If a flag has been raised, then (0, 0, 1, 1) and (1, 1, 0, 0) are accepted as measurement outcomes. The Z error is corrected by applying ZZII (or equivalently IIZZ) down the column. The measurement sequence 90B shows an example in which the quantum computing device 10 flags a correlated ZZII error in the third row.

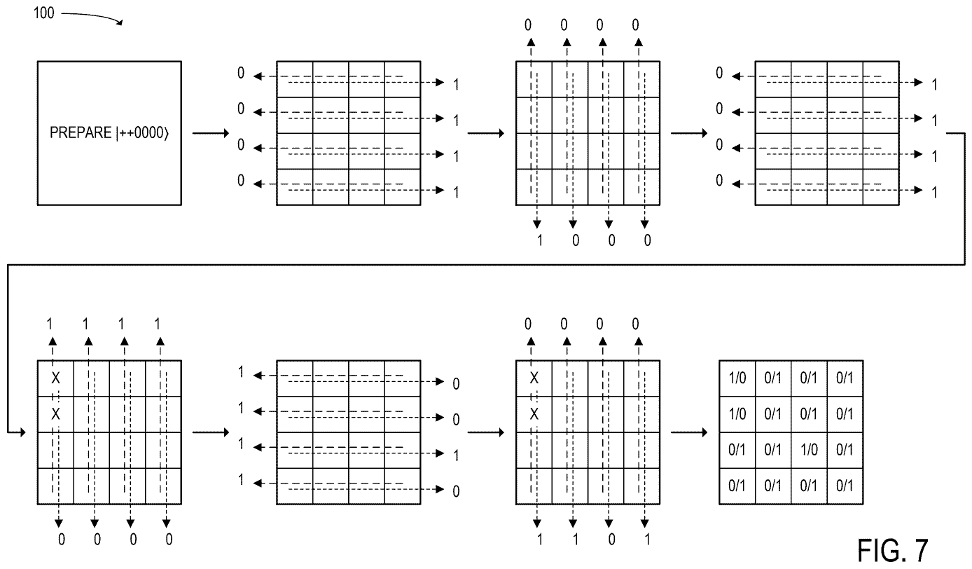

FIG. 7 shows a complete example measurement sequence 100 including three rounds of X and Z error correction, with a flagged Z^{⊗4} measurement leading to an XXII correction applied to that column after the subsequent row-wise stabilizer measurements 64. Starting from the left, each round of error correction includes measuring X^{⊗4} and Z^{⊗4} across four rows, then down four columns, using the circuit 78 shown in FIG. 4D. The error correction rules are “rolling,” meaning that if an error is first detected in the column-wise stabilizer measurements 68, then the subsequent row-wise stabilizer measurements 64 are used to correct that error.

The error correction rules are shown in detail in the following example code:

```
if flagX == −1: # no row flagged already
  if sum(measX) == 2:
    return “postselect”
  if sum(measX) in (1,3):
    if sum(measX) == 1: flagX = measX.index(1)
    else: flagX = measX.index(0)
else: # row flagX in (0,1,2,3) flagged
  if sum(measX) in (1,3):
    if sum(measX) == 1: col = measX.index(1)
    else: col = measX.index(0)
    frameZ[4*flagX + col] += 1 # Z correction
  if sum(measX) == 2:
    if measX in ([0,0,1,1], [1,1,0,0]):
      frameZ[[4*flagX, 4*flagX+1]] += 1 # ZZII
  else:
    return “postselect”
flagX = −1
```

The code presented above processes a Z error for column measurements. The variable measX stores the results of X^{⊗4} measurements on four columns. The variable flagX=−1 if no preceding row X^{⊗4} measurement was flagged. If a row X^{⊗4} measurement is flagged, flagX ∈ {0,1,2,3} indicates the flagged row with a possible weight-one Z error or correlated ZZII or IIZZ error. A Z correction is stored in the Pauli frame. Similar code works for X error correction, and for row X and Z measurements.

It is not obvious that the resulting scheme is fault tolerant. A full argument requires case checking, the difficult case being when there are two faults, e.g., a flagged correlated error and one additional fault. This case does not cause a logical error.

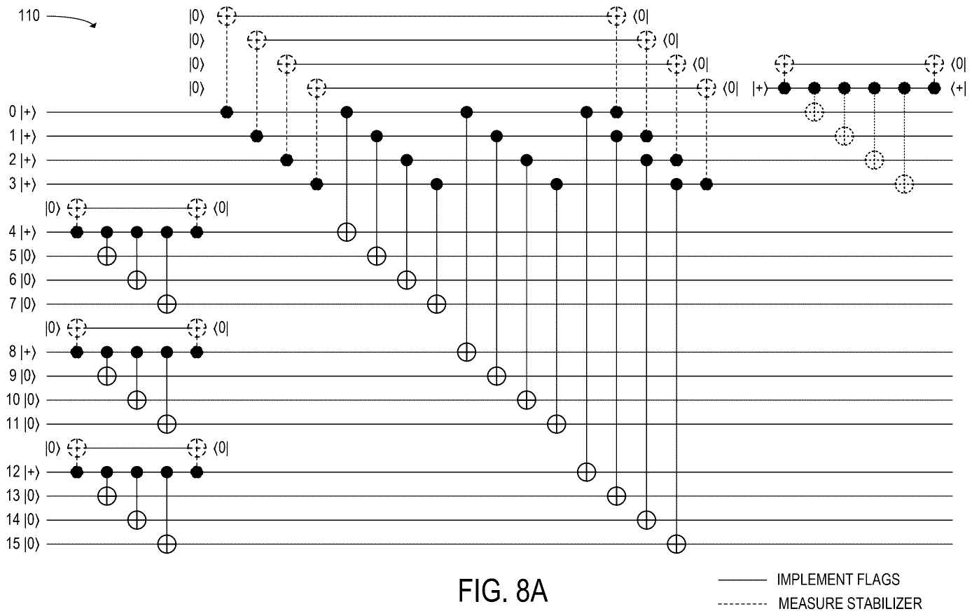

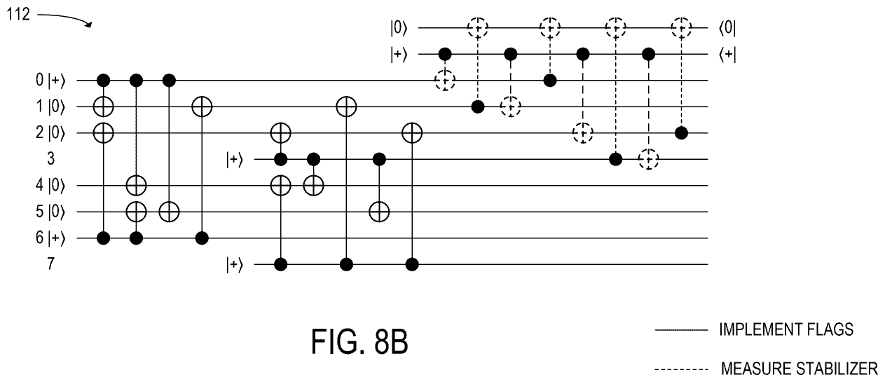

A wide variety of primitives enable fault-tolerant computation with the tesseract subsystem code 50. The following discussion relates to those that are used in the experiments discussed below. These experiments begin by initializing basic encoded states |++0000 [symbol] or |+0+0+0 [symbol] with the initialization circuits 110 and 112 respectively shown in FIGS. 8A-8B. Thus, performing the quantum error correction 60 further includes executing an initialization circuit to prepare a predefined initial state. The predefined initial state is |00++++ [symbol] , |++0000 [symbol] , or |+0+0+0 [symbol] . Performing the quantum error correction 60 further includes performing the one or more row-wise measurement sets 62 and the one or more column-wise measurement sets 64 starting from the predefined initial state.

In the initialization circuits 110 and 112, the flag and syndrome measurements are postselected, meaning that if any measurement is nontrivial, the state is rejected, and its initialization is restarted. Rejections during state preparation are less of a concern than rejections deeper into a computation, when starting over is costly. In the full experimental data below, a preselection rate is shown as the fraction of runs that were rejected during state preparation.

FIG. 8A shows a fault-tolerant postselected initialization circuit 110 that prepares encoded |++0000 [symbol] . FIG. 8B shows a postselected initialization circuit 112. two copies of the initialization circuit 112 may be used to fault-tolerantly prepare the encoded |+0+0+0 [symbol] . Each copy of the initialization circuit 112 prepares |000 [symbol] encoded in the [symbol] 8,3,2 [symbol] color code.

Transversal X and Z measurements, followed by classical decoding, can be used to destructively measure all of the logical X or Z operators fault-tolerantly. Interestingly, there is also a simple procedure for measuring half the logical qubits in the X basis and half in the Z basis. For example, to measure Z, X, Z, X, Z, X, the quantum computing device 10 is further configured to apply row-transversal CNOT gates from row 1 to row 4, and row 2 to row 3. The quantum computing device 10 is further configured to measure each qubit in the top half in the X basis, and each in the bottom in the Z basis. As shown in FIG. 5B, the CNOT gates 82 divide the logical qubits between two [symbol] 8,3,2 [symbol] color codes 84. Although these [symbol] 8,3,2 [symbol] color codes 84 only have distance two, they have distance four in the direction that matters (Z distance four for the top half, X distance four for the bottom), so the measurement results can be decoded reliably. This measurement procedure is used in the repeated error correction experiments below.

Single logical qubits, and some operators across multiple logical qubits, can also be projectively measured with single-shot weight-four measurements. For most codes, this would require multiple repeated rounds of measurements. In the error correction procedure discussed above, the quantum computing device 10 uses this property to measure logical qubits 1 and 2, where the logical qubits are indexed from 1 through 6.

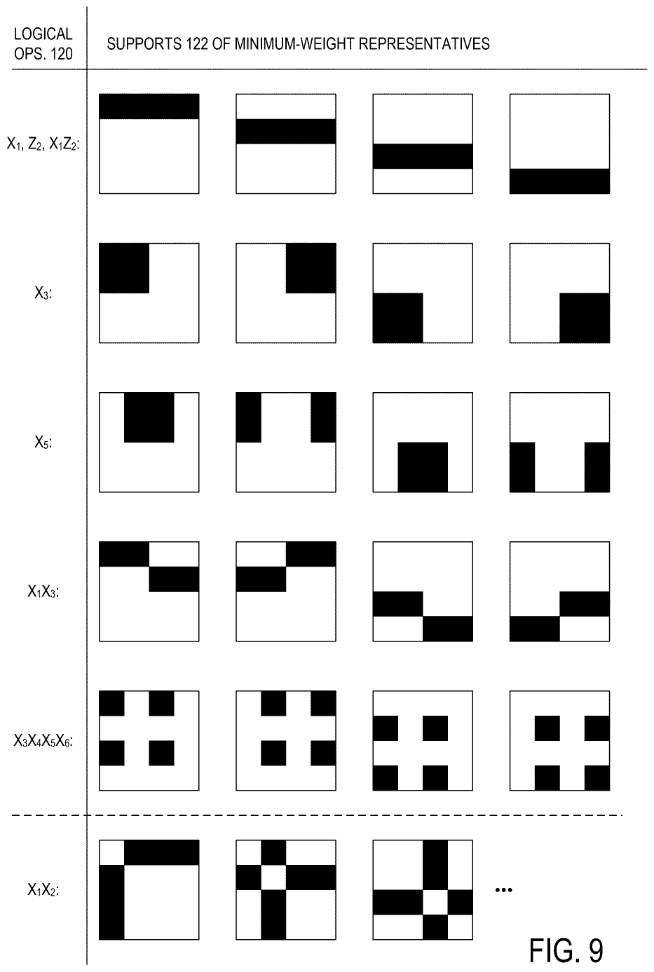

The quantum computing device 10 may, in some examples, be further configured to measure an additional logical operator within the tesseract subsystem code 50 using the two gauge qubits 54E and 54F as workspace qubits. FIG. 9 shows examples of additional logical operators 120. Each logical operator X₁, Z₁, . . . , Z₆ has four qubit-disjoint weight-four representatives. Measuring the representatives fault-tolerantly and taking the majority of the results, postselecting on no tie, fault-tolerantly measures that additional logical operator 120. Many weight-two logical operators can also be measured this way, as well as higher-weight logical operators. Importantly, X or Z logical measurements supported on both qubits of a pair (1,2), (3,4) or (5,6) cannot be measured this way in the general case, as their minimum-weight representatives can have weight six. However, for example, X₁Z₂ has four Y^{⊗4} representatives. FIG. 9 shows a selection of additional logical operators 120 and their minimum-weight representatives' supports 122.

The projective logical measurements allow for measurement-based computation, using the gauge qubits 1 and 2 (among logical qubits indexed from 1 through 6) as workspace. For example, to obtain an encoded CNOT gate from logical qubit i to j, the quantum computing device 10 is configured to start with, say, logical qubit 2 in |0 [symbol] . The quantum computing device 10 is further configured to measure X₂Xᵢ (correcting with Zᵢ if the result is 1), then measure Z₂Zⱼ (correcting with X₂Xᵢ if the result is 1), and finally measure X₂ (correcting with Z₂Zⱼ if the result is 1). The weight-four measurements can be made with either of the circuits 74 or 76 respectively depicted in FIGS. 4B-4C. In the experiments discussed below, the circuit 76 of FIG. 4C was used due to being more efficient. In addition, if a flag is raised, the circuit 76 of FIG. 4C allows the next measurement (in the dual basis) to correct the possible correlated error.

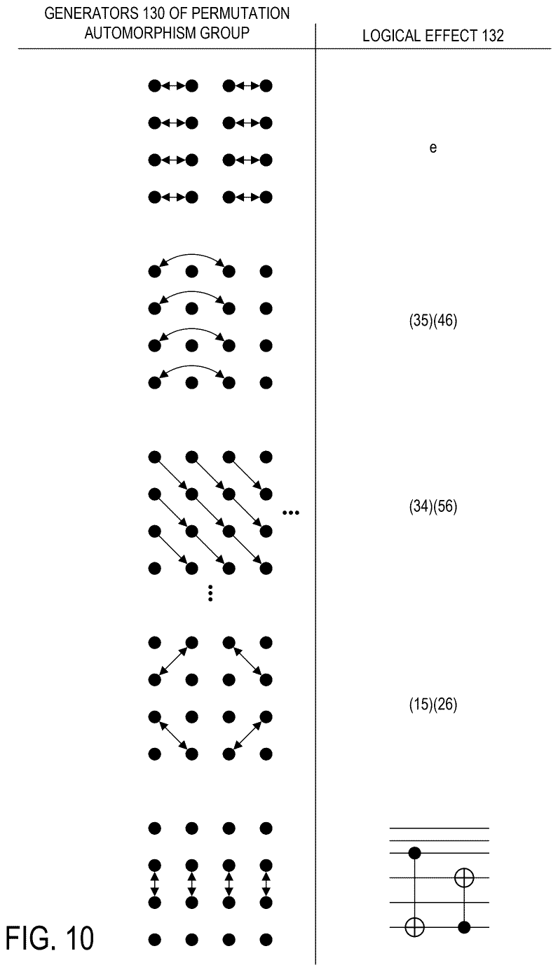

Many qubit permutations preserve the tesseract code space, and they can have a nontrivial logical effect. FIG. 10 shows generators 130 of the group of permutation automorphisms, along with the logical effects 132 of those generators 130. There are 16· 20160 qubit permutations that preserve the tesseract subsystem code 50. For example, applying any of the four permutations e, (12) (34), (13) (24), (14) (23) to the columns and another to the rows (16 possibilities) has trivial logical effect. Note that certain combinations of logical CNOT gates can be implemented with permutations.

The experimental setups and results are discussed below. The first three experiments prepare and verify encoded graph states. Graph states are a rich family of stabilizer states. Preparing graph states reliably is a test of entangling Clifford gates on a quantum computer. In addition to reliably preparing entangled states, these experiments are chosen to demonstrate different capabilities of the tesseract code fault-tolerance scheme, run on Quantinuum's H1-1 and H2-1 quantum computers.

Path-4: this experiment demonstrates an encoded CNOT gate between two logical qubits in the same code block. For codes encoding more than one qubit per block, targeted operations within the block are usually much more difficult than applying the same operation to every encoded qubit. A common technique is to teleport the encoded qubits of interest into their own code blocks that are otherwise empty so that they can be addressed separately. However, this technique wastes the high rate capability of the code. Targeted internal operations without overhead are an important advantage of the tesseract subsystem code 50.

Here and in the other experiments, the basic tesseract code fault-tolerance ingredients discussed above are used as separate modules that are plugged together to obtain an encoded circuit. To prepare the encoded graph state with as high fidelity as possible, a specially tailored encoding circuit would likely have higher performance. The experiments instead focus on demonstrating that the fault-tolerance modules have high performance, since they can be used for a broad variety of experiments.

The unencoded Path-4 experiment uses three CNOT gates, while the encoded experiment gets away with one. The reason is that two of the encoded CNOT gates are implemented at negligible cost by permuting the physical qubits 14P. Permuting qubits is an easy operation for the ion trap hardware used in this experiment.

Cube-8: this experiment demonstrates a deeper logical circuit, on more encoded qubits, and with ample error correction. The circuit involves three rounds of transversal CNOT gates, between two code blocks, with two rounds of error correction on each code block. Without error correction, single faults can cause logical errors, and in simulations the circuit is immediately overwhelmed by noise. The Cube-8 experiment again shows the flexible permutation automorphisms of the tesseract subsystem code 50. Preparing the cube graph state is a challenge because it requires more CNOT gates (12) than any other bipartite eight-qubit graph state.

Cat-12: this experiment shows even more entangled logical qubits. Creating large cat states, also known as GHZ states, is a common metric to demonstrate hardware progress. For example, Quantinuum researchers have prepared the 20-qubit cat state with an 86% fidelity, and the 32-qubit cat state with an 82% fidelity. Using superconducting qubits, Bao et al. have prepared a 60-qubit cat state with a 59% fidelity. The cat state prepared in this experiment has fewer logical qubits, but its fidelity is much higher. This experiment measures X and Z error rates, respectively indicated as p_{X} and p_{Z}, with Table I reporting

$$\frac{1}{2} ( {p}_{X} + {p}_{Z} ) .$$

The fidelity to the ideal cat state is between 1-p_{X}-p_{Z} and 1-max (p_{X}, p_{Z}). From Table III (shown below), the infidelity (1-fidelity) of the physical baseline 12-qubit cat state is at least max (p_{X}, p_{Z})=2.7 (4) %, while the infidelity of the encoded 12-qubit cat state is at most

$${p}_{X} + {p}_{Z} = {0.22}_{- 0.2}^{+ 0.5} \% .$$

As another comparison, Hong et al. have prepared, also on most the H2-1 device, a four-qubit cat state encoded in a [symbol] 25,4,3 [symbol] code with error rates p_{X}=0.3 (1) % and p_{Z}=0.2 (1) %. Bluvstein et al. have prepared, in a neutral atom system, an encoded four-qubit cat state with fidelity 72 (2) %, or up to

$${99.85}_{- 1.}^{0.1} \%$$

postselecting on no detected errors, i.e., with no error correction.

Another experiment included repeated error correction on four and eight qubits. The goal of the repeated error correction experiment was to protect more encoded qubits more strongly, and through more error correction rounds. This is a challenge in and of itself. Reliable repeated error correction may allow deeper logical circuits, since fault tolerance requires periodic error correction.

The details for the encoded and unencoded experiments are provided below. Experimental data, from running the Path-4 experiments on H1-1 and the others on H2-1, is collected in Table III. These experiments demonstrate that the encoded circuits have significantly lower error rates than the unencoded baselines.

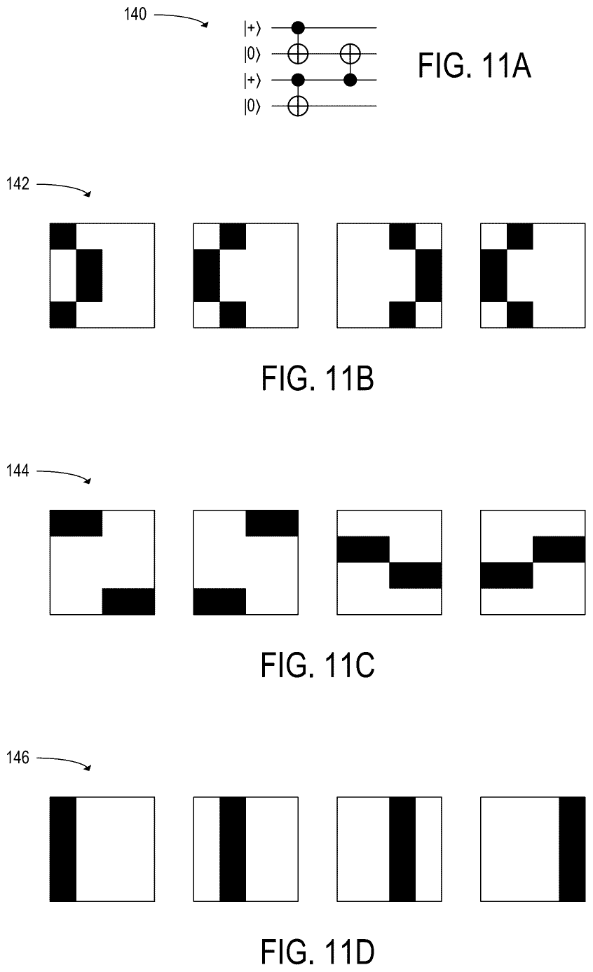

In the Path-4 state preparation experiment, the stabilizers for the 4-qubit path graph state are XXII, IXXX, ZZZI, and IIZZ. The unencoded state preparation circuit 140 is shown in FIG. 11A. This preparation is followed by performing transversal X or Z measurements (6000 shots for each) and counting the fraction of trials in which a stabilizer violation is observed.

The encoded state preparation procedure has four steps:
1. Prepare encoded |+0+0+0 [symbol] as in FIG. 8B.
2. Permute the qubits, as in FIG. 10, to implement two encoded CNOT gates, and get two encoded Bell pairs, on qubits 3, 6 and 4, 5.
3. Implement an encoded CNOT gate from qubit 6 to 5. This is done with three fault-tolerant measurements, using qubit 2 as workspace:
(a) Measure X₂X₆ (correcting Z₂ if the result is 1). This is done by using the circuit 76 of FIG. 4C to measure each of the X^{⊗4} with the supports 142 shown in FIG. 11B.
(b) Measure Z₂Z₅ (correcting X₂X₆ if the result is 1). This is done by measuring the Z^{⊗4} operators with the supports 144 shown in FIG. 11C. Note that each of these Z operators overlaps each of the previous X operators on exactly one qubit. If one of the X measurements was flagged, then the Z measurements can correct the possible X or XX error. A run with two flags is rejected.
(c) Measure X₂ (correcting Z₂Z, if the result is 1). The X^{⊗4} operators have the supports 146 shown in FIG. 11D. Once again, an X or XX error from a flagged Z measurement can be corrected.
4. Transversal X or Z measurement. The measurement results are updated with the stored Pauli frame, then decoded classically, taking into account a possible X measurement flag.

This experiment was conducted on H1-1, with a total of 6000 shots divided between the X and Z measurement settings. 5403 shots were accepted, and, among those, five logical errors were found.

In an earlier version of this experiment, the two-flag circuit 74 of FIG. 4B was used to make the measurements. That setup is slightly simpler, because flags do not have to be passed to the next step. However, in H1 and H2 simulations, the one-flag version has about a 5×lower logical error rate.

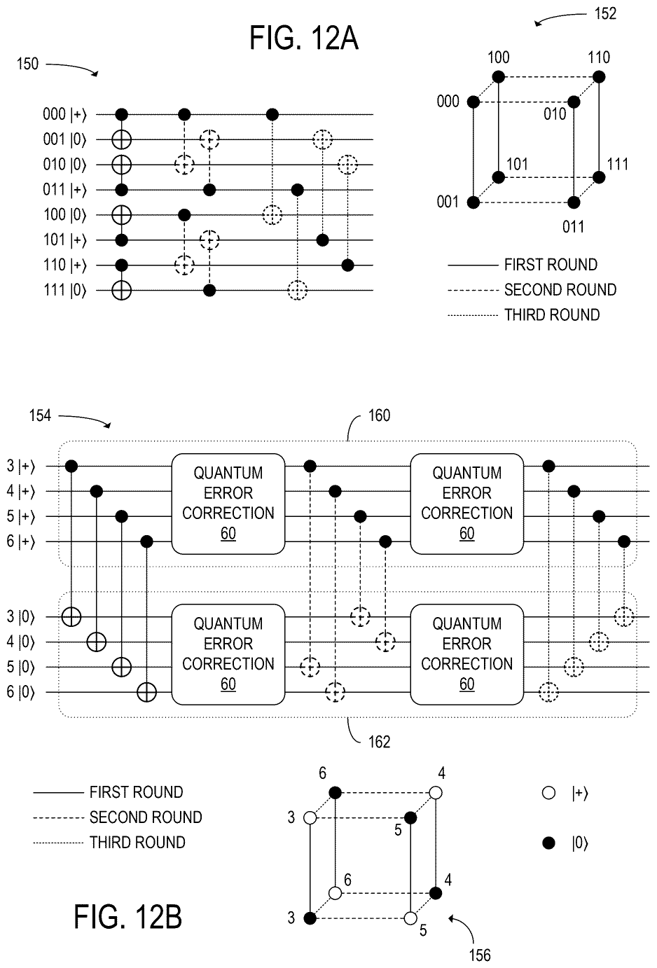

In the cube-8 state preparation experiment, the 8-qubit graph state was prepared using a circuit 150 shown in FIG. 12A. Here, each qubit is labeled by its coordinates in a unit cube 152. The first round of CNOT gates connects qubits differing in the z coordinate, the second round of CNOT gates connects qubits in the y direction, and the third round connects in the x direction. As the cube has 12 edges, there are 12 CNOT gates.

FIG. 12B shows an encoded cube-8 circuit 154 used in the cube-8 state preparation experiment. The encoded procedure starts with encoded |00++++ [symbol] and |++0000 [symbol] in a control block 160 and in a target block 162, prepared as in FIG. 8A. Three rounds of transversal CNOT gates between the blocks 160 and 162 generate the encoded cube state 156 shown in FIG. 12B. In the second and third CNOT gate rounds, the qubits of the target block are permuted so as to permute the encoded qubits. These permutations include swapping two rows in the second round and two columns in the third round. The state is then measured transversally and decoded.

Four instances of quantum error correction 60 are performed in the encoded cube-8 circuit 154 of FIG. 12B, since CNOT gates copy errors between blocks 160 and 162. Without error correction, for example, a single X error on the control block 160 could spread to a weight-three X error on the target block 162, which would decode to a logical error. Fault tolerance requires only X error correction on the control block and Z error correction on the target block. However, X and Z errors were corrected on both blocks in the cube-8 experiment.

Note that when interpreting the results, measurement flags are also passed between the blocks. For example, if a column in the control block 160 is flagged for a possible XX error, since that error would be copied to the target block 162, the flag is also copied. If the target block 162 was already flagged for an X or XX error, the trial is rejected. Aside from passing flags like this, correlated error decoding between the blocks 160 and 162 is not used.

In the Cat-12 state preparation experiment, the 12-qubit cat state

$$\frac{1}{\sqrt{2}} ( \vert {0}^{12} + \vert {1}^{12} )$$

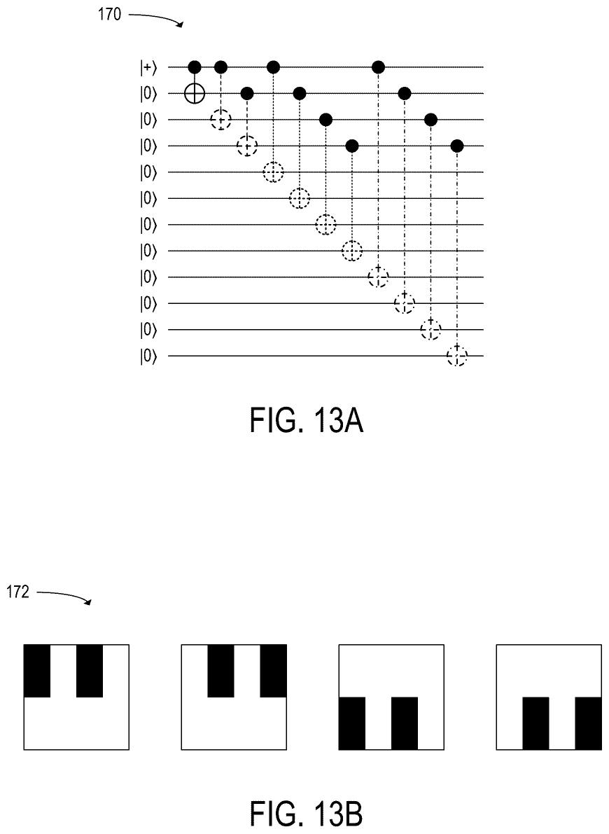

can be prepared with four rounds of CNOT gates, resulting in 11 CNOTs total. FIG. 13A shows a circuit 170 that prepares the 12-qubit cat state. The 12-qubit cat state is a graph state for the star graph. In this experiment, the 12-qubit cat state is compared to the dual cat state

$$\frac{1}{\sqrt{2}} ( \vert {+}^{12} + \vert {-}^{12} ) ,$$

since it has slightly lower error rates in simulation.

To prepare the encoded cat state on three code blocks, the preparation procedure begins by preparing an encoded cat state |0⁴ [symbol] +|1⁴ [symbol] in qubits 3, 4, 5, and 6 of one code block. This is similar to the Path-4 experiment, but simpler:
1. Prepare encoded |+0+0+0 [symbol] , as in FIG. 8B.
2. Permute the qubits, as in FIG. 10, to implement two encoded CNOT gates, and get two encoded Bell pairs, on qubits 3, 6 and 4, 5.
3. Finally, merge the two Bell pairs by measuring Z₄Z₆ (correcting X₃X₆ if the result is 1). This is done by using the one-flag circuit 76 shown in FIG. 4C to measure each of the Z^{⊗4} operators with the supports 172 shown in FIG. 13B.

Transversal CNOT gates are then applied to two copies of |++0000 [symbol] and all 48 physical qubits 14P are measured in the X or Z basis. With transversal X measurements, the classical decoder takes into account that one of the Z measurements may have a raised flag, indicating a possible ZZ error in the first code block.

Although there are 12 encoded qubits, using all 56 physical qubits 14P in H2-1, the encoded circuit is shallower and simpler than in the Cube-8 experiment.

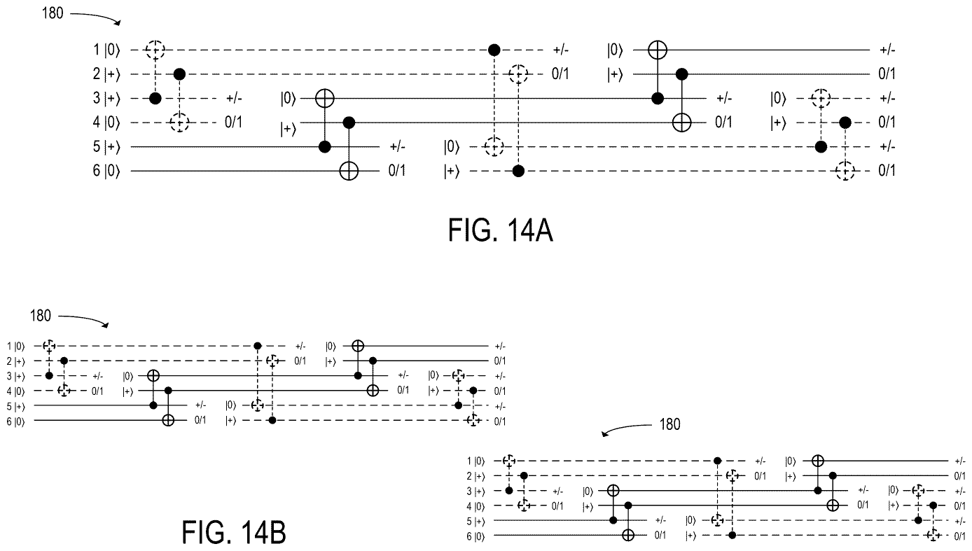

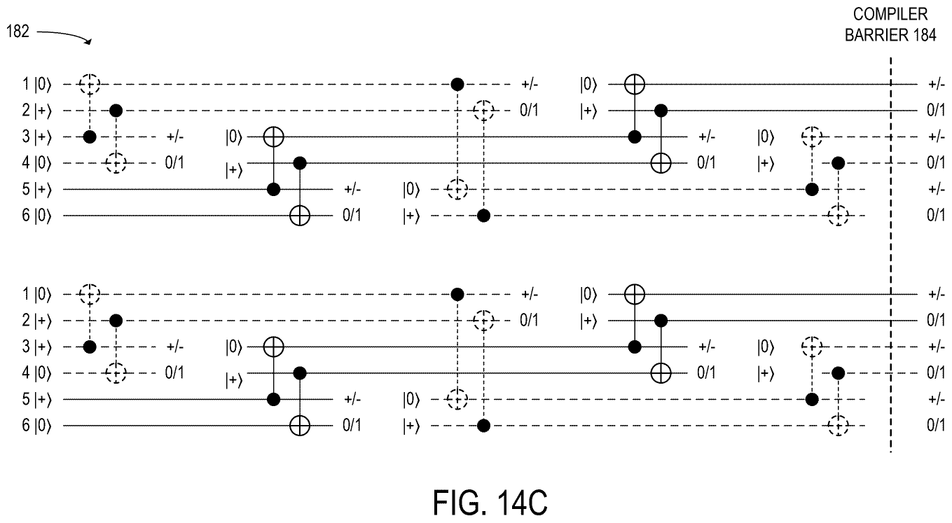

The unencoded physical baseline for the repeated error correction experiment is the circuit 180 shown in FIG. 14A. This circuit 180 includes five rounds that each include two one-qubit teleportation steps. The Pauli corrections for the one-qubit teleportations are not shown but are Z for X measurements and X for Z measurements. This circuit 180 is interpreted such that data qubits 3, 4, 5, 6 cyclically rotate through the six qubit positions. A trial is successful if in the end, after Pauli corrections, the final four measurement outcomes are +, 0, +, 0. Otherwise, the trial has an error.

In the eight-qubit version of this experiment, the above circuit 180 is repeated twice in parallel, as shown in FIG. 14B. Parallelization of the circuits, rather than sequential execution, is enforced by inserting a compiler barrier 184 on all eight data qubits before the final measurements to obtain the circuit 182 shown in FIG. 14C. This forces all operations before the compiler barrier 184 to finish before any operations after it begin. Sequential execution would be easier, since it lets the device devote its limited parallelism to one block at a time. Sequential execution also uses fewer qubits in memory.

The encoded version of repeated error correction is not just repeated error correction with alternating row and column measurements, as in FIG. 7. The baseline comparison for that experiment would be four idling physical qubits 14P, and idle ion trap qubits can be used as memory. Instead, a more complicated version of repeated error correction was implemented. This version of repeated error correction concurrently makes the above cyclic one-qubit teleportations among the six encoded qubits. This alternative error correction experiment proceeds as follows:
1. Prepare encoded |+0+0+0 [symbol] , as in FIG. 8B.
2. Measure together encoded Z₁ and X₂ to initialize encoded |0++0+0 [symbol] . If the Z₁ outcome is 1, correct with X₁. If the X₂ outcome is 1, correct with Z₂.
3. Repeat five times:
(a) Measure together X₁X₃ (correction Z₁) and Z₂Z₄ (correction X₂) using the circuit 78 of FIG. 4D.
(b) Rotate the encoded qubits cyclically forward two steps, i.e., with the permutation (3, 1, 5) (4, 2, 6). This logical permutation is implemented with the physical qubit permutation (0, 2, 5) (3, 6, 4) (8, 15, 10) (9, 12, 14).
(c) Measure Z₁ (correction X₁X₅) and X₂ (correction Z₂Z₆) by measuring X^{⊗4} and Z^{⊗4} down each column. This restores the gauge qubits to |0+ [symbol] .

In each step, the four X^{⊗4} and Z^{⊗4} measurement outcomes are used to correct errors, including possible flagged correlated errors, as in the example of FIG. 7.
4. Destructively measure encoded X₃, Z₄, X₅, Z₆. As discussed above, and similarly to the example of FIG. 5B, apply row-transversal CNOT gates from row 1 to row 2 and from row 4 to row 3; then measure each control qubit in the X basis and each target qubit in the Z basis. Decoding the [symbol] 8,3,2 [symbol] code for the control half gives X₃ and X₅, while decoding the target half gives Z₄ and Z₆.

In the repeated error correction example of FIG. 7, the logical measurement outcomes do not matter, i.e., measurements 0000 and 1111 are treated as equivalents. The states of the gauge qubits are irrelevant in the example of FIG. 7. However, in this experiment the logical measurement outcomes do matter, since they determine the one-qubit teleportation Pauli corrections. Accordingly, this experiment is slightly more challenging than the example measurement sequence 100 of FIG. 7.

Table III: Experimental data. A run is “preselected” out if it is rejected during the initial state preparation of encoded |00++++ [symbol] , |++0000 [symbol] , or |+0+0+0 [symbol] . The preparation circuits allow preselection to occur with first-order probability in the error rate; this is acceptable because only that block's initialization is restarted and not the whole computation. A run is “postselected” out if it is rejected any time after the initial state preparation, due to two faults being detected in close proximity. With distance-four fault tolerance, postselection occurs with a second-order probability.

| | Meas. | | | | Acceptance | | |
|---|---|---|---|---|---|---|---|
| Experiment | basis | Runs | Preselected | Postselected | rate | Errors | Error rate |
| Path-4 encoded | X | 3000 | 220 | 89 | 90(1)% | 3 | ${0.12}_{- 0.09}^{+ 0.18} \%$ |
| | Z | 3000 | 192 | 96 | 90(1)% | 2 | ${0.08}_{- 0.06}^{+ 0.16} \%$ |
| Path-4 unencoded | X | 6000 | — | — | — | 88 | 1.5(3)% |
| | Z | 6000 | — | — | — | 88 | 1.5(3)% |
| Cube-8 encoded | X | 2000 | 298 | 272 | 71(2)% | 2 | ${0.2}_{- 0.1}^{+ 0.3} \%$ |
| | Z | 2000 | 256 | 238 | 75(2)% | 3 | ${0.2}_{- 0.2}^{+ 0.3} \%$ |
| Cube-8 | X | 6000 | — | — | — | 151 | 2.5(4)% |
| unencoded | | | | | | | |
| | Z | 6000 | — | — | — | 119 | ${2.}_{- 0.3}^{+ 0.4} \%$ |
| Cat-12 encoded | X | 1600 | 377 | 39 | 74(2)% | 0 | ${0.02}_{- 0.02}^{+ 0.19} \%$ |
| | Z | 1600 | 380 | 25 | 75(2)% | 2 | ${0.2}_{- 0.2}^{+ 0.3} \%$ |
| Cat-12 unencoded | X | 6000 | — | — | — | 130 | ${2.2}_{- 0.3}^{+ 0.4} \%$ |
| | Z | 6000 | — | — | — | 163 | 2.7(4)% |
| 5 rounds of 4-qubit error | — | 2500 | 297 | 148 | ${82}_{- 2}^{+ 1} \%$ | 2 | ${0.11}_{- 0.09}^{+ 0.21} \%$ |
| correction | | | | | | | |
| Teleportation | — | 6000 | — | — | — | 163 | 2.7(4)% |
| baseline | | | | | | | |
| 5 rounds of 8-qubit error | | 1200 | 339 | 245 | 51(3)% | 3 | ${0.5}_{- 0.4}^{+ 0.8} \%$ |
| correction | | | | | | | |
| Teleportation | | 6000 | — | — | — | 338 | 5.6(6)% |
| baseline | | | | | | | |

Quantinuum has a state-vector emulator for their H2-1 system that is highly accurate for small experiments such as the physical baseline comparisons on up to 12 qubits. It is less accurate for the experiments on one code block, tending to underestimate acceptance probabilities. Nonetheless, up to rounds of the one-qubit teleportation version of error correction were simulated on one code block.

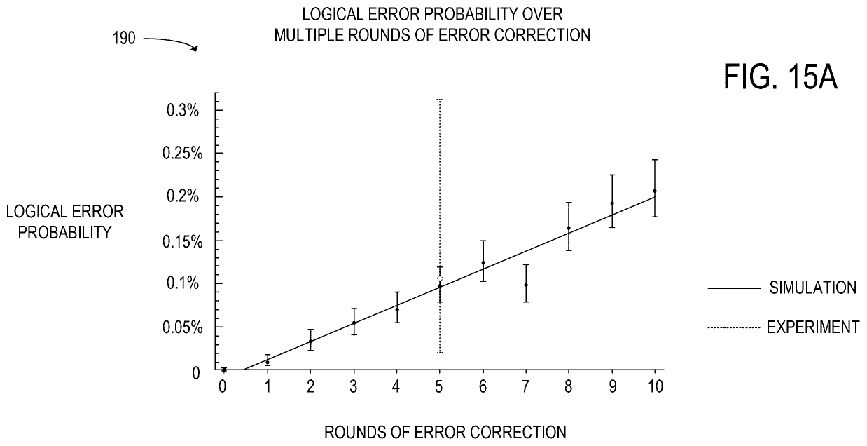

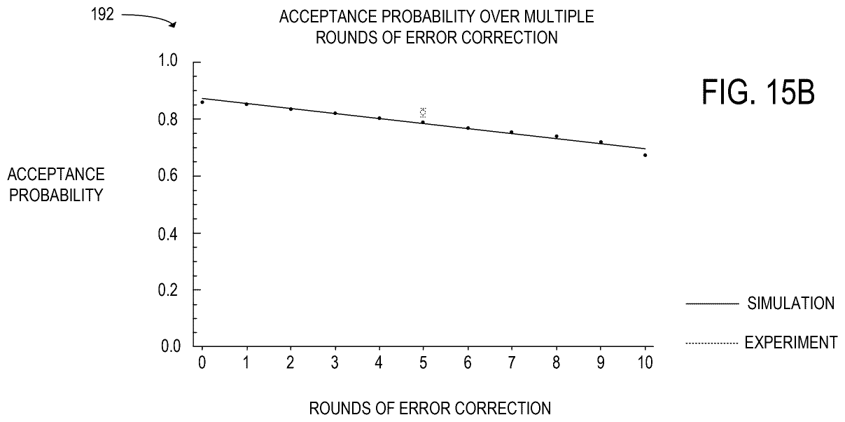

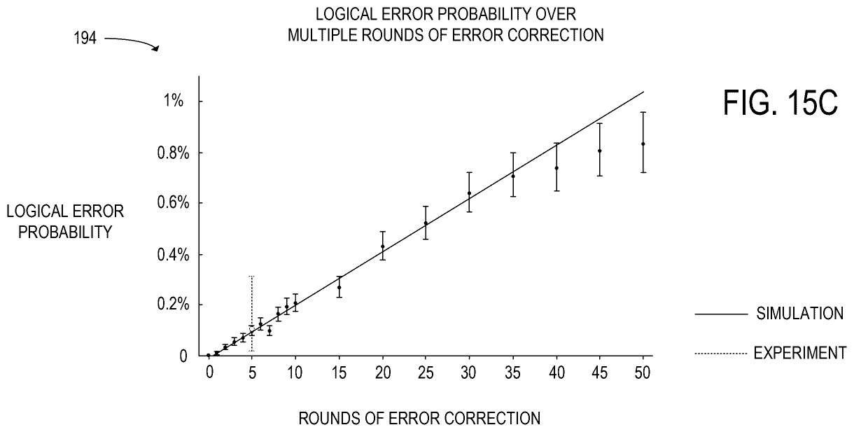

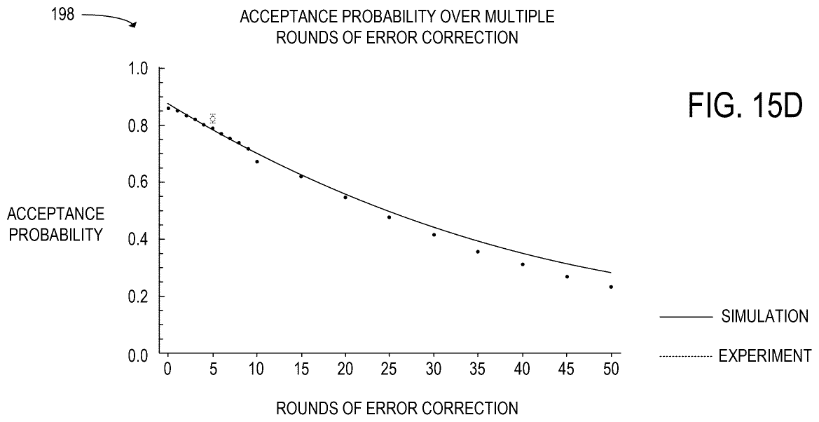

FIGS. 15A-15D show plots of the simulated logical error and acceptance probabilities. FIG. 15A shows a plot 190 of simulated data indicating the logical error probability versus rounds of error correction, on one code block. FIG. 15B shows a plot 192 of simulated data indicating acceptance probability versus rounds of error correction, on one code block. In addition, FIGS. 15A and 15B show experimental data from the five-round experiment.

FIG. 15C shows a plot 194 of logical error probability versus rounds of error correction in an example in which simulations were extended to 50 rounds of error correction. FIG. 15D shows a plot 196 of acceptance probability versus rounds of error correction when 50 rounds were simulated. The fit line and exponential respectively shown in FIGS. 15C and 15D are still based on the first 10 rounds.

In the plots shown in FIGS. 15A-15D, the growth of the logical error probability is at least consistent with a straight line, as expected, while the acceptance probability has a slow exponential decline. The acceptance rate starts below 1 because about 13.6% of runs are discarded due to a detected state preparation error. In the first 10 error correction rounds, the logical error rate increases by 2.0 (2)×10-4 per round, i.e., this is the slope of the fit line, and 2:23 (3) % of the surviving trials are discarded.

Similar simulations were not run for two code blocks, because the state-vector emulator cannot simulate the 36 qubits this would require. The stabilizer emulator can simulate all 56 qubits in the H2-1 device, but while it can be useful for guidance it is not accurate enough in 18+-qubit simulations to draw conclusions.

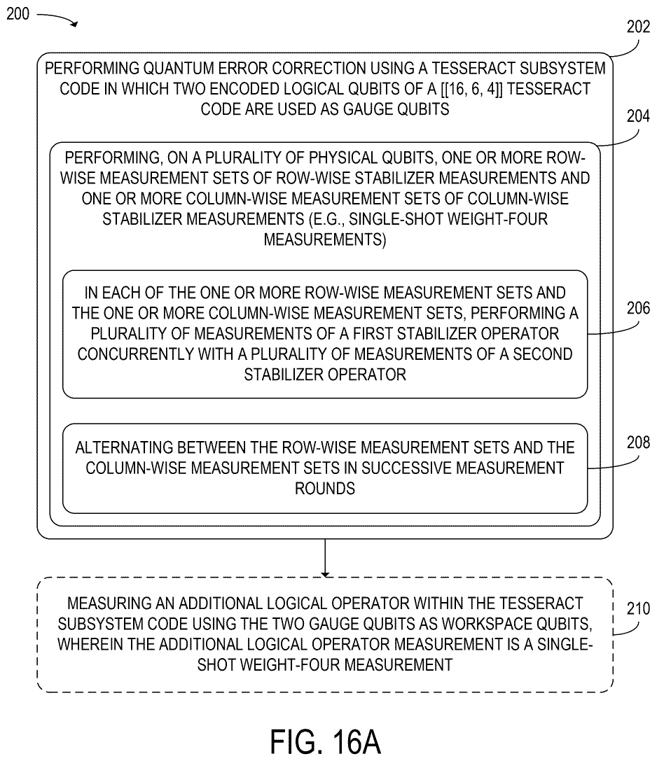

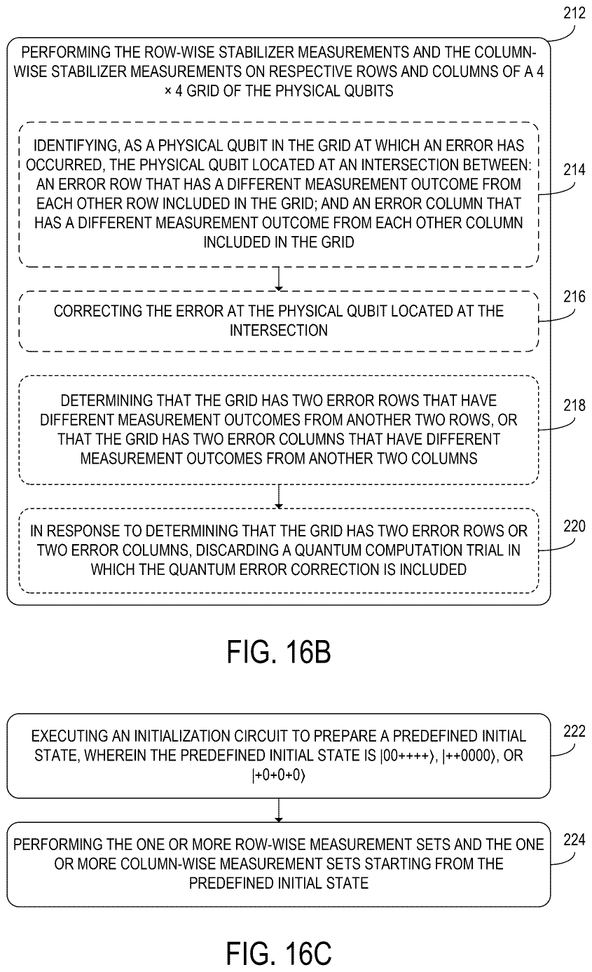

FIG. 16A shows a flowchart of a method 200 for use with a quantum computing device. At step 202, the method 200 includes performing quantum error correction using a tesseract subsystem code in which two encoded logical qubits of a [symbol] 16, 6, 4 [symbol] tesseract code are used as gauge qubits. Those two encoded logical qubits are dedicated to error correction despite having a code distance of four, whereas gauge qubits in other quantum error correction codes typically have a code distance of two.

At step 204, performing the quantum error correction at step 202 may include performing, on a plurality of physical qubits, one or more row-wise measurement sets of row-wise stabilizer measurements. Step 204 may further include performing one or more column-wise measurement sets of column-wise stabilizer measurements. The row-wise stabilizer measurements and the column-wise stabilizer measurements may each be single-shot weight-four measurements.

In some examples, at step 206, step 204 may include performing a plurality of measurements of a first stabilizer operator concurrently with a plurality of measurements of a second stabilizer operator. In such examples, the measurements of the first stabilizer operator and the second stabilizer operator may be performed in each of the one or more row-wise measurement sets and the one or more column-wise measurement sets. The first stabilizer operator may be X^{⊗4} and the second stabilizer operator may be Z^{⊗4}.

At step 208, step 204 may further include alternating between the row-wise measurement sets and the column-wise measurement sets in successive measurement rounds. Thus, performing the quantum error correction may include alternating between row-wise stabilizer measurements and column-wise stabilizer measurements.

In some examples, at step 210, the method 200 may further include measuring an additional logical operator within the tesseract subsystem code using the two gauge qubits as workspace qubits. The additional logical operator measurement may be a single-shot weight-four measurement. Thus, in addition to quantum error correction, the tesseract subsystem code may be used to efficiently implement measurement-based logical operations. Although step 210 is shown after step 202 in the example of FIG. 16A, one or more additional logical operators may also be measured within the tesseract subsystem code prior to performing the quantum error correction. Thus, errors that occur in the one or more additional logical operators may be corrected at step 202 in such examples.

FIG. 16B shows additional steps of the method of FIG. 16A that may be performed in some examples. The steps shown in FIG. 16B may be performed when the one or more row-wise measurement sets and the one or more column-wise measurement sets are performed at step 204. At step 212, step 204 may include performing the row-wise stabilizer measurements and the column-wise stabilizer measurements on respective rows and columns of a 4×4 grid of the physical qubits.

At step 214, step 212 may include identifying, as a physical qubit in the grid at which an error has occurred, the physical qubit located at an intersection between an error row and an error column. The error row, in this example, is a row of the 4×4 grid that has a different measurement outcome from each other row included in the grid. Similarly, the error column is a column of the 4×4 grid that has a different measurement outcome from each other column included in the grid. At step 216, step 212 may further include correcting the error at the physical qubit located at the intersection.

In some examples, at step 218, step 212 may instead include determining that the grid has two error rows that have different measurement outcomes from another two rows, or that the grid has two error columns that have different measurement outcomes from another two columns. In such examples, it may be ambiguous which pair of rows or columns have incurred errors. At step 220, in response to determining that the grid has two error rows or two error columns, step 212 may further include discarding a quantum computation trial in which the quantum error correction is included. In other examples in which two error rows or error columns are detected, the quantum computation trial may still be maintained when a previous measurement round has indicated an error column (in examples in which two error rows are detected) or an error row (in examples in which two error columns are detected). The previous error flag may be used to resolve the ambiguity as to which two rows or columns incurred the errors, thereby allowing those errors to be corrected.

FIG. 16C shows additional steps of the method of FIG. 16A that may be performed in some examples. At step 222, the method 200 may further include executing an initialization circuit to prepare a predefined initial state. The predefined initial state may be |00++++ [symbol] , |++0000 [symbol] , or |+0+0+0 [symbol] . At step 224, the method 200 may further include performing the one or more row-wise measurement sets and the one or more column-wise measurement sets starting from the predefined initial state. Accordingly, the quantum computing device sets the initial values of the logical qubits prior to performing quantum error correction.

Using the tesseract subsystem code discussed above, quantum error correction may be performed in a manner that achieves significantly lower logical error rates than unencoded baselines. The tesseract subsystem code allows for efficient single-shot error correction with two ancilla qubits. The tesseract subsystem code may also be used to encode other logical operations, thereby allowing some operators to be implemented with fault-tolerant measurements.

The methods and processes described herein are tied to a computing system of one or more computing devices. In particular, such methods and processes can be implemented as a computer-application program or service, an application-programming interface (API), a library, and/or other computer-program product.

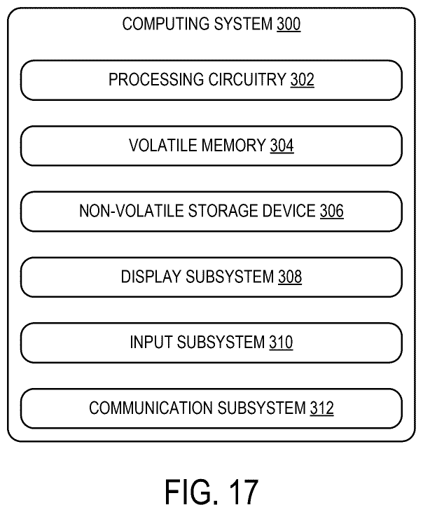

FIG. 17 schematically shows a non-limiting embodiment of a computing system 300 that can enact one or more of the methods and processes described above. Computing system 300 may be used to instantiate the classical computing device used as the controller 18 of the quantum computing device 10. Computing system 300 is shown in simplified form. Components of computing system 300 may, for example, be included in one or more server computing devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 17.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a quantum computing device is provided. The quantum computing device is configured to perform quantum error correction using a tesseract subsystem code in which two encoded logical qubits of a [symbol] 16, 6, 4 [symbol] tesseract code are used as gauge qubits. The above features may have the technical effect of allowing quantum error correction to be performed with a low logical error rate. The quantum error correction may also be performed efficiently in terms of both time and number of physical qubits.

According to this aspect, the quantum computing device may be configured to perform the quantum error correction at least in part by performing, on a plurality of physical qubits, one or more row-wise measurement sets of row-wise stabilizer measurements and performing one or more column-wise measurement sets of column-wise stabilizer measurements. The one or more row-wise measurement sets and the one or more column-wise measurement sets may each include a plurality of measurements of a first stabilizer operator that are performed concurrently with a plurality of measurements of a second stabilizer operator. The above features may have the technical effect of performing quantum error correction in a parallelized, time-efficient manner.

According to this aspect, when performing the quantum error correction, the quantum computing device may be configured to alternate between the row-wise measurement sets and the column-wise measurement sets in successive measurement rounds. The above features may have the technical effect of performing time-efficient stabilizer measurements.

According to this aspect, the quantum computing device may be configured to perform the row-wise stabilizer measurements and the column-wise stabilizer measurements on respective rows and columns of a 4×4 grid of the physical qubits. The above features may have the technical effect of performing fault-tolerant, parallelized stabilizer measurements.

According to this aspect, performing the quantum error correction may further include identifying, as a physical qubit in the grid at which an error has occurred, the physical qubit located at an intersection between an error row that has a different measurement outcome from each other row included in the grid and an error column that has a different measurement outcome from each other column included in the grid. The above features may have the technical effect of identifying an error that has occurred at a physical qubit.

According to this aspect, the quantum computing device may be further configured to determine that the grid has two error rows that have different measurement outcomes from another two rows, or that the grid has two error columns that have different measurement outcomes from another two columns. In response to determining that the grid has two error rows or two error columns, discard a quantum computation trial in which the quantum error correction is included. The above features may have the technical effect of discarding quantum computation trials in which ambiguous error detections occur.

According to this aspect, the row-wise stabilizer measurements and the column-wise stabilizer measurements may each be single-shot weight-four measurements. The above features may have the technical effect of performing the stabilizer measurements in a time-efficient manner.

According to this aspect, performing the quantum error correction may further include executing an initialization circuit to prepare a predefined initial state, wherein the predefined initial state is |00++++ [symbol] , |++0000 [symbol] , or |+0+0+0 [symbol] . Performing the quantum error correction may further include performing the one or more row-wise measurement sets and the one or more column-wise measurement sets starting from the predefined initial state. The above features may have the technical effect of setting the initial state of the logical qubits prior to performing the quantum error correction.

According to this aspect, the quantum computing device is further configured to measure an additional logical operator within the tesseract subsystem code using the two gauge qubits as workspace qubits. The above features may have the technical effect of achieving increased space efficiency at the quantum computing device by reusing the gauge qubits.

According to this aspect, the additional logical operator measurement is a single-shot weight-four measurement. The above feature may have the technical effect of efficiently performing the additional logical operator measurement.

According to another aspect of the present disclosure, a method for use with a quantum computing device is provided. The method includes performing quantum error correction using a tesseract subsystem code in which two encoded logical qubits of a [symbol] 16, 6, 4 [symbol] tesseract code are used as gauge qubits. The above features may have the technical effect of allowing quantum error correction to be performed with a low logical error rate. The quantum error correction may also be performed efficiently in terms of both time and number of physical qubits.

According to this aspect, performing the quantum error correction may include performing, on a plurality of physical qubits, one or more row-wise measurement sets of row-wise stabilizer measurements and performing one or more column-wise measurement sets of column-wise stabilizer measurements. The one or more row-wise measurement sets and the one or more column-wise measurement sets may each include a plurality of measurements of a first stabilizer operator that are performed concurrently with a plurality of measurements of a second stabilizer operator. The above features may have the technical effect of performing quantum error correction in a parallelized, time-efficient manner.

According to this aspect, performing the quantum error correction may include alternating between the row-wise measurement sets and the column-wise measurement sets in successive measurement rounds. The above features may have the technical effect of performing time-efficient stabilizer measurements.

According to this aspect, the row-wise stabilizer measurements and the column-wise stabilizer measurements may be performed on respective rows and columns of a 4×4 grid of the physical qubits. The above features may have the technical effect of performing fault-tolerant, parallelized stabilizer measurements.

According to this aspect, performing the quantum error correction may further include identifying, as a physical qubit in the grid at which an error has occurred, the physical qubit located at an intersection between an error row that has a different measurement outcome from each other row included in the grid and an error column that has a different measurement outcome from each other column included in the grid. The above features may have the technical effect of identifying an error that has occurred at a physical qubit.

According to this aspect, the method may further include determining that the grid has two error rows that have different measurement outcomes from another two rows, or that the grid has two error columns that have different measurement outcomes from another two columns. In response to determining that the grid has two error rows or two error columns, the method may further include discarding a quantum computation trial in which the quantum error correction is included. The above features may have the technical effect of discarding quantum computation trials in which ambiguous error detections occur.

According to this aspect, the row-wise stabilizer measurements and the column-wise stabilizer measurements may each be single-shot weight-four measurements. The above features may have the technical effect of performing the stabilizer measurements in a time-efficient manner.

According to this aspect, performing the quantum error correction may further include executing an initialization circuit to prepare a predefined initial state, wherein the predefined initial state is |00++++ [symbol] , |++0000 [symbol] , or |+0+0+0 [symbol] . Performing the quantum error correction may further include performing the one or more row-wise measurement sets and the one or more column-wise measurement sets starting from the predefined initial state. The above features may have the technical effect of setting the initial state of the logical qubits prior to performing the quantum error correction.

According to this aspect, the method may further include measuring an additional logical operator within the tesseract subsystem code using the two gauge qubits as workspace qubits, wherein the additional logical operator measurement is a single-shot weight-four measurement. The above features may have the technical effect of achieving increased space efficiency at the quantum computing device by reusing the gauge qubits.

According to another aspect of the present disclosure, a computing system is provided, including a processor configured to control a quantum computing device to perform quantum error correction using a tesseract subsystem code in which two encoded logical qubits of a [symbol] 16, 6, 4 [symbol] tesseract code are used as gauge qubits. The above features may have the technical effect of allowing quantum error correction to be performed with a low logical error rate. The quantum error correction may also be performed efficiently in terms of both time and number of physical qubits.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A quantum computing device configured to perform quantum error correction using a tesseract subsystem code in which two encoded logical qubits of a [symbol] 16, 6, 4 [symbol] tesseract code are used as gauge qubits.

2. The quantum computing device of claim 1, wherein:
the quantum computing device is configured to perform the quantum error correction at least in part by performing, on a plurality of physical qubits, one or more row-wise measurement sets of row-wise stabilizer measurements and performing one or more column-wise measurement sets of column-wise stabilizer measurements; and
the one or more row-wise measurement sets and the one or more column-wise measurement sets each include a plurality of measurements of a first stabilizer operator that are performed concurrently with a plurality of measurements of a second stabilizer operator.

3. The quantum computing device of claim 2, wherein, when performing the quantum error correction, the quantum computing device is configured to alternate between the row-wise measurement sets and the column-wise measurement sets in successive measurement rounds.

4. The quantum computing device of claim 2, wherein the quantum computing device is configured to perform the row-wise stabilizer measurements and the column-wise stabilizer measurements on respective rows and columns of a 4×4 grid of the physical qubits.

5. The quantum computing device of claim 4, wherein performing the quantum error correction further includes identifying, as a physical qubit in the grid at which an error has occurred, the physical qubit located at an intersection between:
an error row that has a different measurement outcome from each other row included in the grid; and
an error column that has a different measurement outcome from each other column included in the grid.

6. The quantum computing device of claim 5, wherein the quantum computing device is further configured to:
determine that the grid has two error rows that have different measurement outcomes from another two rows, or that the grid has two error columns that have different measurement outcomes from another two columns; and
in response to determining that the grid has two error rows or two error columns, discard a quantum computation trial in which the quantum error correction is included.

7. The quantum computing device of claim 2, wherein the row-wise stabilizer measurements and the column-wise stabilizer measurements are each single-shot weight-four measurements.

8. The quantum computing device of claim 2, wherein performing the quantum error correction further includes:
executing an initialization circuit to prepare a predefined initial state, wherein the predefined initial state is |00++++ [symbol] , |++0000 [symbol] , or |+0+0+0 [symbol] ; and
performing the one or more row-wise measurement sets and the one or more column-wise measurement sets starting from the predefined initial state.

9. The quantum computing device of claim 1, wherein the quantum computing device is further configured to measure an additional logical operator within the tesseract subsystem code using the two gauge qubits as workspace qubits.

10. The quantum computing device of claim 9, wherein the additional logical operator measurement is a single-shot weight-four measurement.

11. A method for use with a quantum computing device, the method comprising performing quantum error correction using a tesseract subsystem code in which two encoded logical qubits of a [symbol] 16, 6, 4 [symbol] tesseract code are used as gauge qubits.

12. The method of claim 11, wherein:
performing the quantum error correction includes performing, on a plurality of physical qubits, one or more row-wise measurement sets of row-wise stabilizer measurements and performing one or more column-wise measurement sets of column-wise stabilizer measurements; and
the one or more row-wise measurement sets and the one or more column-wise measurement sets each include a plurality of measurements of a first stabilizer operator that are performed concurrently with a plurality of measurements of a second stabilizer operator.

13. The method of claim 12, wherein, performing the quantum error correction includes alternating between the row-wise measurement sets and the column-wise measurement sets in successive measurement rounds.

14. The method of claim 12, wherein the row-wise stabilizer measurements and the column-wise stabilizer measurements are performed on respective rows and columns of a 4×4 grid of the physical qubits.

15. The method of claim 14, wherein performing the quantum error correction further includes identifying, as a physical qubit in the grid at which an error has occurred, the physical qubit located at an intersection between:
an error row that has a different measurement outcome from each other row included in the grid; and
an error column that has a different measurement outcome from each other column included in the grid.

16. The method of claim 15, further comprising:
determining that the grid has two error rows that have different measurement outcomes from another two rows, or that the grid has two error columns that have different measurement outcomes from another two columns; and
in response to determining that the grid has two error rows or two error columns, discarding a quantum computation trial in which the quantum error correction is included.

17. The method of claim 12, wherein the row-wise stabilizer measurements and the column-wise stabilizer measurements are each single-shot weight-four measurements.

18. The method of claim 12, wherein performing the quantum error correction further includes:
executing an initialization circuit to prepare a predefined initial state, wherein the predefined initial state is |00++++ [symbol] , |++0000 [symbol] , or |+0+0+0 [symbol] ; and
performing the one or more row-wise measurement sets and the one or more column-wise measurement sets starting from the predefined initial state.

19. The method of claim 11, further comprising measuring an additional logical operator within the tesseract subsystem code using the two gauge qubits as workspace qubits, wherein the additional logical operator measurement is a single-shot weight-four measurement.

20. A computing system comprising:
a processor configured to control a quantum computing device to:
perform quantum error correction using a tesseract subsystem code in which two encoded logical qubits of a [symbol] 16, 6, 4 [symbol] tesseract code are used as gauge qubits.
